(19) United States
(12) Patent Application Publication
(10) Pub. No.: US 2015/0099161 A1
(43) Pub. Date: Apr. 9, 2015

(54) POWER STORAGE UNIT

(71) Applicant: Semiconductor Energy Laboratory Co., Ltd., Atsugi-shi (JP)

(72) Inventors: Aya HITOTSUYANAGI, Atsugi (JP); Teppei OGUNI, Atsugi (JP); Takuya MIWA, Atsugi (JP); Hiroyuki MIYAKE, Atsugi (JP)

(21) Appl. No.: 14/490,697

(22) Filed: Sep. 19, 2014

(30) Foreign Application Priority Data
Oct. 4, 2013 (JP) 2013-208840

(51) Int. Cl. H01M 10/04; H01M 4/485; H01M 10/0525; H01M 4/38; H01M 4/62; H01M 4/58; H01M 4/583

(52) U.S. Cl. CPC H01M 10/04; H01M 4/5825; H01M 4/485; H01M 4/583; H01M 4/386; H01M 4/622; H01M 4/623; H01M 10/0525; H01M 2220/20; H01M 2220/30
USPC 429/163; 429/209; 429/221; 429/231.3; 429/231.8; 429/218.1; 429/217

(57) ABSTRACT

To achieve a power storage unit that can be repeatedly bent without a large decrease in charge and discharge capacity. In the flexible power storage unit, the content of a binder in an active material layer containing an active material is greater than or equal to 1 wt % and less than or equal to 10 wt %, preferably greater than or equal to 2 wt % and less than or equal to 8 wt %, and more preferably greater than or equal to 3 wt % and less than or equal to 5 wt %.

### BACKGROUND OF THE INVENTION

1. Field of the Invention

One embodiment of the present invention relates to an object, a method, or a manufacturing method. In addition, one embodiment of the present invention relates to a process, a machine, manufacture, or a composition of matter. In particular, one embodiment of the present invention relates to a semiconductor device, a display device, a light-emitting device, a power storage device, a memory device, a driving method thereof, or a manufacturing method thereof. More particularly, one embodiment of the present invention relates to a power storage unit and a manufacturing method thereof.

Note that in this specification, a power storage unit is a collective term describing units and devices having a power storage function. Also in this specification, an electrochemical device is a collective term describing devices that can function using a power storage unit, a conductive layer, a resistor, a capacitor, and the like.

2. Description of the Related Art

In recent years, a variety of power storage units, for example, secondary batteries such as lithium-ion secondary batteries, lithium-ion capacitors, and air batteries, have been actively developed. In particular, demand for lithium-ion secondary batteries with high output and high energy density has rapidly grown with the development of the semiconductor industry, for example, in the field of portable information terminals such as mobile phones, smartphones, and laptop computers; electrical appliances such as portable music players and digital cameras; medical equipment; and next-generation clean energy vehicles such as hybrid electric vehicles (HEVs), electric vehicles (EVs), and plug-in hybrid electric vehicles (PHEVs). The lithium-ion secondary batteries as rechargeable energy sources are thus essential for today's information society.

The performance required for the lithium-ion batteries includes increased energy density, improved cycle characteristics, safe operation under a variety of environments, and longer-term reliability.

Also in recent years, flexible display devices have been proposed to be mounted on a curved surface or worn on the human body such as head. This has increased demand for flexible power storage units that can be attached to a curved surface.

An example of a lithium-ion battery includes at least a positive electrode, a negative electrode, and an electrolyte solution (Patent Document 1).

### REFERENCE

### Patent Document

[Patent Document 1] Japanese Published Patent Application No. 2012-009418

### SUMMARY OF THE INVENTION

The charge and discharge capacity of a flexible power storage unit decreases with repeated bending. In view of this problem, an object of one embodiment of the present invention is to achieve, for example, a power storage unit that can be repeatedly bent without a large decrease in charge and discharge capacity.

Another object of one embodiment of the present invention is to achieve an electrode or the like that is unlikely to deteriorate. Still another object of one embodiment of the present invention is to provide a novel power storage unit or the like. Note that the description of these objects does not disturb the existence of other objects. In one embodiment of the present invention, there is no need to achieve all the objects. Other objects will be apparent from and can be derived from the description of the specification, the drawings, the claims, and the like.

The inventors have focused on a binding agent (a binder) which is mixed to increase the adhesion of an active material, and have achieved a power storage unit that can be repeatedly bent without a large decrease in charge and discharge capacity.

For example, the content of the binder in an active material layer containing the active material is greater than or equal to 1 wt % and less than or equal to 10 wt %, preferably greater than or equal to 2 wt % and less than or equal to 8 wt %, and more preferably greater than or equal to 3 wt % and less than or equal to 5 wt %.

One embodiment of the present invention is a power storage unit including a positive electrode provided with a positive electrode active material layer containing a first binding agent, and a negative electrode provided with a negative electrode active material layer containing a second binding agent. The content of the first binding agent in the positive electrode active material layer is greater than or equal to 1 wt % and less than or equal to 10 wt %.

One embodiment of the present invention is a power storage unit including a positive electrode provided with a positive electrode active material layer containing a first binding agent, and a negative electrode provided with a negative electrode active material layer containing a second binding agent. The content of the second binding agent in the negative electrode active material layer is greater than or equal to 1 wt % and less than or equal to 10 wt %.

One embodiment of the present invention is a power storage unit including a positive electrode provided with a positive electrode active material layer containing a first binding agent, and a negative electrode provided with a negative electrode active material layer containing a second binding agent. The content of the first binding agent in the positive electrode active material layer is greater than or equal to 1 wt % and less than or equal to 10 wt %. The content of the second binding agent in the negative electrode active material layer is greater than or equal to 1 wt % and less than or equal to 10 wt %.

A power storage unit or the like that can be repeatedly bent without a large decrease in charge and discharge capacity can be provided. A novel power storage unit or the like can be provided. Note that the description of these effects do not disturb the existence of other effects. One embodiment of the present invention does not necessarily have all of these effects. Other effects will be apparent from and can be derived from the description of the specification, the drawings, the claims, and the like.

### BRIEF DESCRIPTION OF THE DRAWINGS

In the accompanying drawings:

FIGS. 1A and 1B illustrate an example of a positive electrode;

FIGS. 2A and 2B illustrate an example of a negative electrode;

FIGS. 3A and 3B illustrate an example of a laminated power storage unit;

FIGS. 4A to 4C illustrate examples of a coin-type power storage unit;

FIGS. 5A and 5B illustrate an example of a cylindrical power storage unit;

FIGS. 6A and 6B illustrate an example of a power storage unit;

FIGS. 7A-1 and 7A-2, and FIGS. 7B-1 and 7B-2 illustrate examples of a power storage unit;

FIGS. 8A and 8B illustrate examples of a power storage unit;

FIGS. 9A and 9B illustrate examples of a power storage unit;

FIG. 10 illustrates an example of a power storage unit;

FIGS. 11A to 11E illustrate examples of an electronic device using a power storage unit;

FIGS. 12A to 12C illustrate an example of an electronic device using a power storage unit;

FIG. 13 illustrates examples of an electronic device using a power storage unit;

FIGS. 14A and 14B illustrate examples of a vehicle using a power storage unit;

FIG. 15A is a photograph showing the appearance of a repeated bending test machine, and FIGS. 15B and 15C are diagrams thereof;

FIGS. 16A and 16B show the measurement results of charge and discharge capacity; and

FIGS. 17A and 17B show discharge capacity retention rates.

### DETAILED DESCRIPTION OF THE INVENTION

Embodiments of the present invention will be described in detail with reference to the accompanying drawings. Note that one embodiment of the present invention is not limited to the description below, and it is easily understood by those skilled in the art that modes and details disclosed herein can be modified in various ways. Furthermore, one embodiment of the present invention is not construed as being limited to description of the following embodiments.

Note that in each drawing referred to in this specification, the size of each component or the thickness of each layer might be exaggerated or a region might be omitted for clarity of the invention. Therefore, embodiments of the invention are not limited to such scales.

Note that ordinal numbers such as “first” and “second” in this specification and the like are used in order to avoid confusion among components and do not denote the priority or the order such as the order of steps or the stacking order. A term without an ordinal number in this specification and the like might be provided with an ordinal number in a claim in order to avoid confusion among components.

### Embodiment 1

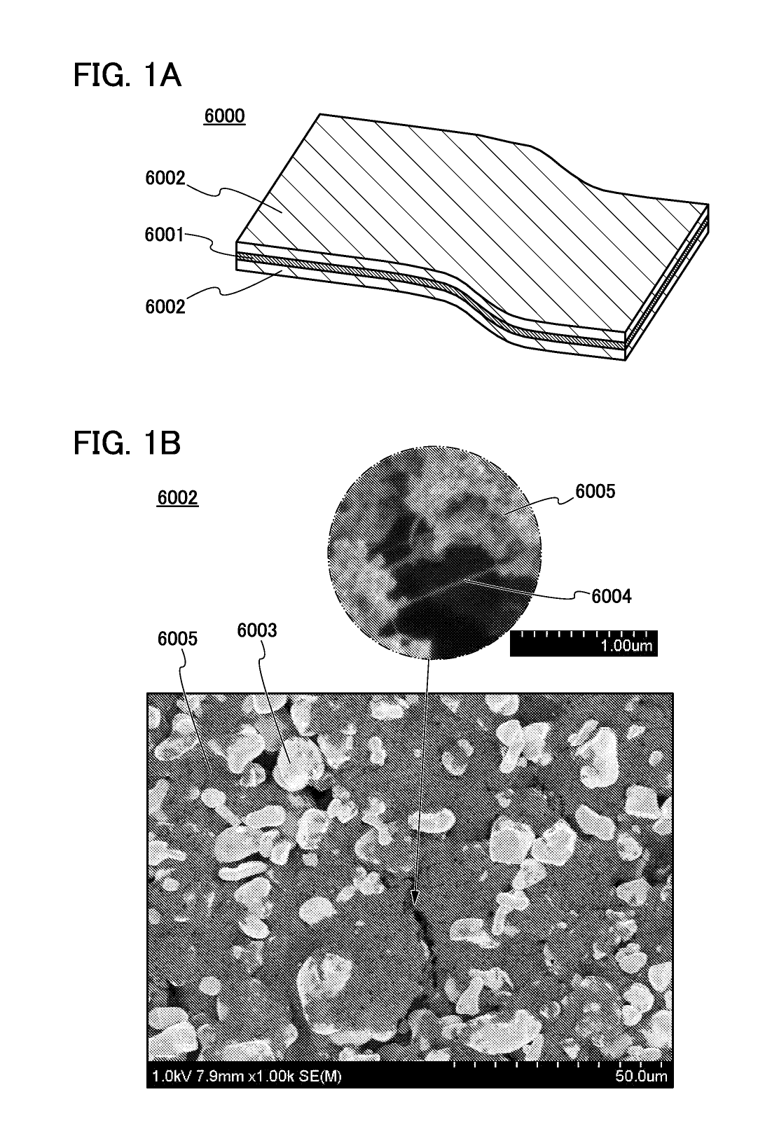

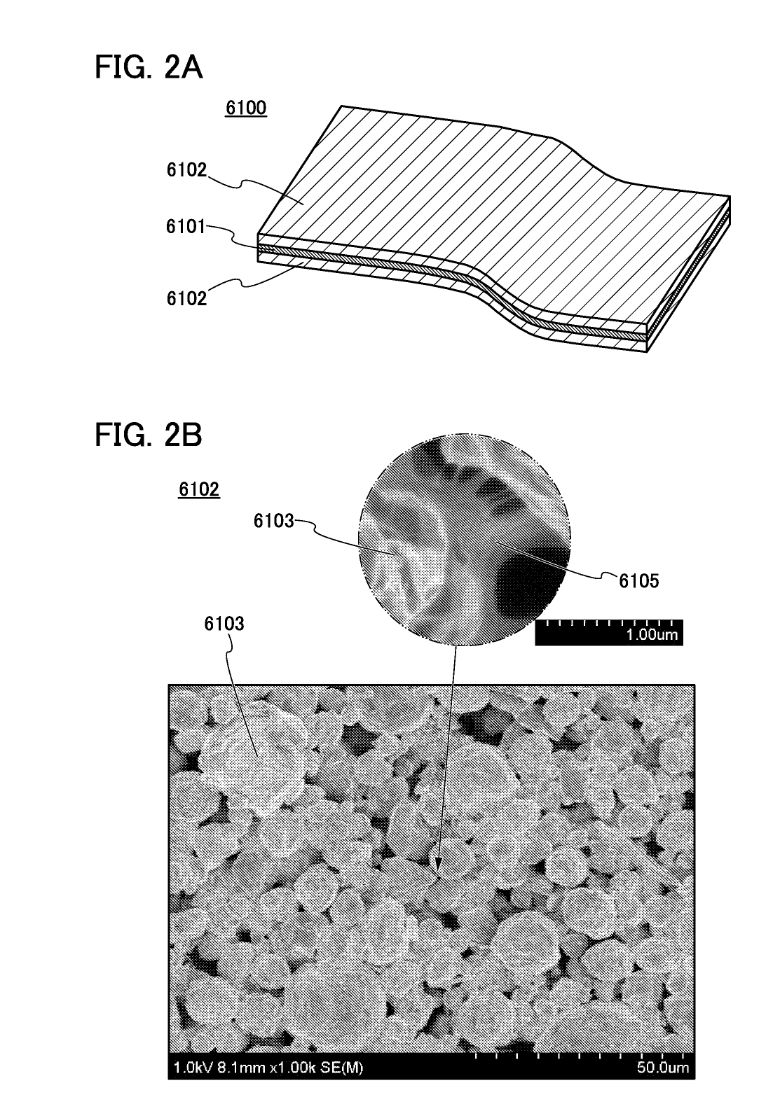

An example of the structure of a power storage unit will be described with reference to FIGS. 1A and 1B and FIGS. 2A and 2B.

### [1. Positive Electrode]

First, an example of a positive electrode of the power storage unit will be described with reference to FIGS. 1A and 1B.

A positive electrode 6000 includes, for example, a positive electrode current collector 6001 and positive electrode active material layers 6002 formed on the positive electrode current collector 6001. FIG. 1A shows an example in which the positive electrode active material layer 6002 is provided on both surfaces of the positive electrode current collector 6001 with a sheet shape (or a strip-like shape); however, one embodiment of the present invention is not limited to this example. The positive electrode active material layer 6002 may be provided on one of the surfaces of the positive electrode current collector 6001. Furthermore, although the positive electrode active material layer 6002 is provided on the entire surface of the positive electrode current collector 6001 in FIG. 1A, one embodiment of the present invention is not limited thereto. The positive electrode active material layer 6002 may be provided on part of the positive electrode current collector 6001. For example, the positive electrode active material layer 6002 does not need to be provided in a portion where the positive electrode current collector 6001 is connected to a positive electrode tab.

The positive electrode current collector 6001 can be formed using a material that has a high conductivity, such as a metal like gold, platinum, zinc, iron, copper, aluminum, or titanium, or an alloy thereof (e.g., stainless steel). Alternatively, the positive electrode current collector 6001 can be formed using an aluminum alloy to which an element that improves heat resistance, such as silicon, titanium, neodymium, scandium, or molybdenum, is added. Further alternatively, the positive electrode current collector 6001 may be formed using a metal element that forms silicide by reacting with silicon. Examples of the metal element that forms silicide by reacting with silicon include zirconium, titanium, hafnium, vanadium, niobium, tantalum, chromium, molybdenum, tungsten, cobalt, and nickel. The positive electrode current collector 6001 may have a foil shape, a plate (sheet) shape, a net shape, a punching-metal shape, an expanded-metal shape, or the like as appropriate. The positive electrode current collector 6001 preferably has a thickness greater than or equal to 5 μm and less than or equal to 30 μm. The surface of the positive electrode current collector 6001 may be provided with an undercoat using graphite or the like.

FIG. 1B shows a photograph of the surface of the positive electrode active material layer 6002, which is observed with a scanning electron microscope (SEM). The positive electrode active material layer 6002 includes particles of a positive electrode active material 6003, a conductive additive 6004, and a binder 6005.

The positive electrode active material 6003 is in the form of particles made of secondary particles having an average particle diameter and particle diameter distribution, which are obtained in such a way that material compounds are mixed at a predetermined ratio and baked and the resulting baked product is crushed, granulated, and classified by an appropriate means. For this reason, the shape of the positive electrode active material 6003 is not limited to that illustrated in FIG. 1B. The shape of the positive electrode active material 6003 may be a given shape such as a particle shape, a plate shape, a rod shape, a cylindrical shape, a powder shape, or a flake shape. Furthermore, the positive electrode active material 6003 may have a three-dimensional shape such as unevenness on a surface with a plate shape, fine unevenness on a surface, or a porous shape.

As the positive electrode active material 6003, a material into/from which carrier ions such as lithium ions can be inserted and extracted is used, and examples of the material include a lithium-containing material having an olivine crystal structure, a layered rock-salt crystal structure, or a spinel crystal structure.

Typical examples of the lithium-containing material with an olivine crystal structure (general formula: LiMPO₄ (M is one or more of Fe(II), Mn(II), Co(II), and Ni(II))) include LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b≦1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e≦1, 0<c<1, 0<d<1, and 0<e<1), and LiFe_{f}Ni_{g}CoₕMnᵢPO₄ (f+g+h+i≦1, 0<f<1, 0<g<1, 0<h<1, and 0<i<1).

LiFePO₄ is particularly preferable because it properly has properties necessary for the positive electrode active material, such as safety, stability, high capacity density, high potential, and the existence of lithium ions that can be extracted in initial oxidation (charge).

Examples of the lithium-containing material with a layered rock-salt crystal structure include lithium cobalt oxide (LiCoO₂), LiNiO₂, LiMnO₂, Li₂MnO₃, NiCo-based lithium-containing material (general formula: LiNiₓCo₁₋ₓO₂ (0<x<1)) such as LiNi_{0.8}Co_{0.2}O₂, NiMn-based lithium-containing material (general formula: LiNiₓMn₁₋ₓO₂ (0<x<1)) such as LiNi_{0.5}Mn_{0.5}O₂, NiMnCo-based lithium-containing material (also referred to as NMC) (general formula: LiNiₓMn_{y}Co_{1-x-y}O₂ (x>0, y>0, x+y<1)) such as LiNi_{1/3}Mn_{1/3}Co_{1/3}O₂, Li(Ni_{0.8}Co_{0.15}Al_{0.05})O₂, and Li₂MnO₃—LiMO₂ (M=Co, Ni, or Mn).

LiCoO₂ is particularly preferable because it has high capacity, stability in the air higher than that of LiNiO₂, and thermal stability higher than that of LiNiO₂, for example.

Examples of the lithium-containing material with a spinel crystal structure include LiMn₂O₄, Li₁₊ₓMn₂₋ₓO₄, Li(MnAl)₂O₄, and LiMn_{1.5}Ni_{0.5}O₄.

It is preferable to add a small amount of lithium nickel oxide (LiNiO₂ or LiNi₁₋ₓMO₂ (M=Co, Al, or the like)) to the lithium-containing material with a spinel crystal structure that contains manganese such as LiMn₂O₄, in which case the elution of manganese and the decomposition of an electrolyte solution can be suppressed, for example.

A composite oxide expressed by Li_{(2-f)}MSiO₄ (general formula) (M is one or more of Fe(II), Mn(II), Co(II), and Ni(II), 0≦j≦2) can also be used as the positive electrode active material. Typical examples of the general formula Li₍₂₋ⱼ₎MSiO₄ include Li₍₂₋ⱼ₎FeSiO₄, Li₍₂₋ⱼ₎NiSiO₄, Li₍₂₋ⱼ₎CoSiO₄, Li₍₂₋ⱼ₎MnSiO₄, Li₍₂₋ⱼ₎FeₖNiₗSiO₄, Li₍₂₋ⱼ₎FeₖCoₗSiO₄, Li₍₂₋ⱼ₎FeₖMnₗSiO₄, Li₍₂₋ⱼ₎NiₖCoₗSiO₄, Li₍₂₋ⱼ₎NiₖMnₗSiO₄ (k+l≦1, 0<k<1, and 0<l<1), Li₍₂₋ⱼ₎FeₘNiₙCo_{q}SiO₄, Li₍₂₋ⱼ₎FeₘNiₙMn_{q}SiO₄, Li₍₂₋ⱼ₎NiₘCoₙMn_{q}SiO₄ (m+n+q≦1, 0<m<1, 0<n<1, and 0<q<1), and Li₍₂₋ⱼ₎FeᵣNiₛCoₜMnᵤSiO₄ (r+s+t+u≦1, 0<r<1, 0<s<1, 0<t<1, and 0<u<1).

Alternatively, a nasicon compound represented by a general formula A₂M₂(XO₄)₃ (A=Li, Na, or Mg, M=Fe, Mn, Ti, V, Nb, or Al, X=S, P, Mo, W, As, or Si) can be used as the positive electrode active material. Examples of the nasicon compound include Fe₂(MnO₄)₃, Fe₂(SO₄)₃, and Li₃Fe₂(PO₄)₃. Further alternatively, a compound represented by a general formula Li₂MPO₄F, Li₂MP₂O₇, or Li₅MO₄ (M=Fe or Mn), a perovskite fluoride such as NaF₃ or FeF₃, a metal chalcogenide (a sulfide, a selenide, or a telluride) such as TiS₂ or MoS₂, a lithium-containing material with an inverse spinel crystal structure such as LiMVO₄, a vanadium oxide (V₂O₅, V₆O₁₃, LiV₃O₈, or the like), a manganese oxide, an organic sulfur compound, or the like can be used as the positive electrode active material.

In the case where carrier ions are alkali metal ions other than lithium ions, or alkaline-earth metal ions, the positive electrode active material 6003 may contain, instead of lithium in the compound and the oxide, an alkali metal (e.g., sodium or potassium), an alkaline-earth metal (e.g., calcium, strontium, barium, beryllium, or magnesium). For example, the positive electrode active material may be a layered oxide containing sodium such as NaFeO₂ or Na_{2/3}[Fe_{1/2}Mn_{1/2}]O₂.

Further alternatively, any of the aforementioned materials may be combined to be used as the positive electrode active material. For example, the positive electrode active material may be a solid solution containing any of the aforementioned materials, e.g., a solid solution containing LiCo_{1/3}Mn_{1/3}Ni_{1/3}O₂ and Li₂MnO₃.

Although not illustrated, a carbon layer or an oxide layer such as a zirconium oxide layer may be provided on a surface of the positive electrode active material 6003. The carbon layer or the oxide layer increases the conductivity of an electrode. The positive electrode active material 6003 can be coated with the carbon layer by mixing a carbohydrate such as glucose at the time of baking the positive electrode active material.

The average particle diameter of the primary particle of the positive electrode active material 6003 is preferably greater than or equal to 50 nm and less than or equal to 100 μm.

Examples of the conductive additive 6004 include acetylene black (AB), graphite (black lead) particles, carbon nanotubes, graphene, and fullerene.

A network for electron conduction can be formed in the positive electrode 6000 by the conductive additive 6004. The conductive additive 6004 also allows maintaining of a path for electric conduction between the particles of the positive electrode active material 6003. The addition of the conductive additive 6004 to the positive electrode active material layer 6002 increases the electron conductivity of the positive electrode active material layer 6002.

A typical example of the binder 6005 is polyvinylidene fluoride (PVDF), and other examples of the binder 6005 include polyimide, polytetrafluoroethylene, polyvinyl chloride, ethylene-propylene-diene polymer, styrene-butadiene rubber, acrylonitrile-butadiene rubber, fluorine rubber, polyvinyl acetate, polymethyl methacrylate, polyethylene, and nitrocellulose.

The content of the binder 6005 in the positive electrode active material layer 6002 is preferably greater than or equal to 1 wt % and less than or equal to 10 wt %, more preferably greater than or equal to 2 wt % and less than or equal to 8 wt %, and still more preferably greater than or equal to 3 wt % and less than or equal to 5 wt %. The content of the conductive additive 6004 in the positive electrode active material layer 6002 is preferably greater than or equal to 1 wt % and less than or equal to 10 wt %, more preferably greater than or equal to 1 wt % and less than or equal to 5 wt %.

In the case where the positive electrode active material layer 6002 is formed by a coating method, the positive electrode active material 6003, the binder 6005, and the conductive additive 6004 are mixed to form a positive electrode paste (slurry), and the positive electrode paste is applied to the positive electrode current collector 6001 and dried.

### [2. Negative Electrode]

Next, an example of a negative electrode of the power storage unit will be described with reference to FIGS. 2A and 2B.

A negative electrode 6100 includes, for example, a negative electrode current collector 6101 and negative electrode active material layers 6102 formed on the negative electrode current collector 6101. FIG. 2A shows an example in which the negative electrode active material layer 6102 is provided on both surfaces of the negative electrode current collector 6101 with a sheet shape (or a strip-like shape); however, one embodiment of the present invention is not limited to this example. The negative electrode active material layer 6102 may be provided on one of the surfaces of the negative electrode current collector 6101. Furthermore, although the negative electrode active material layer 6102 is provided on the entire surface of the negative electrode current collector 6101 in FIG. 2A, one embodiment of the present invention is not limited thereto. The negative electrode active material layer 6102 may be provided on part of the negative electrode current collector 6101. For example, the negative electrode active material layer 6102 does not need to be provided in a portion where the negative electrode current collector 6101 is connected to a negative electrode tab.

The negative electrode current collector 6101 can be formed using a material that has a high conductivity and is not alloyed with carrier ions such as lithium ions, e.g., a metal such as platinum, iron, copper, titanium, tantalum, or manganese, or an alloy thereof (e.g., stainless steel). Alternatively, the negative electrode current collector 6101 may be formed using a metal element that forms silicide by reacting with silicon. Examples of the metal element that forms silicide by reacting with silicon include zirconium, titanium, hafnium, vanadium, niobium, tantalum, chromium, molybdenum, tungsten, cobalt, and nickel. The negative electrode current collector 6101 may have a foil shape, a plate (sheet) shape, a net shape, a punching-metal shape, an expanded-metal shape, or the like as appropriate. The negative electrode current collector 6101 preferably has a thickness greater than or equal to 5 μm and less than or equal to 30 μm. The surface of the negative electrode current collector 6101 may be provided with an undercoat using graphite or the like.

FIG. 2B shows a photograph of the surface of the negative electrode active material layer 6102, which is observed with a scanning electron microscope (SEM). FIG. 2B shows an example in which the negative electrode active material layer 6102 includes a negative electrode active material 6103 and a binder (binding agent) 6105, though a conductive additive may be added to the negative electrode active material layer 6102.

There is no particular limitation on the material of the negative electrode active material 6103 as long as it is a material with which lithium can be dissolved and precipitated or a material into/from which lithium ions can be inserted and extracted. Other than a lithium metal or lithium titanate, a carbon-based material generally used in the field of power storage, or an alloy-based material can also be used as the negative electrode active material 6103.

The lithium metal is preferable because of its low redox potential (which is lower than that of the standard hydrogen electrode by 3.045 V) and high specific capacity per unit weight and per unit volume (3860 mAh/g and 2062 mAh/cm³).

Examples of the carbon-based material include graphite, graphitizing carbon (soft carbon), non-graphitizing carbon (hard carbon), a carbon nanotube, graphene, and carbon black.

Examples of the graphite include artificial graphite such as meso-carbon microbeads (MCMB), coke-based artificial graphite, or pitch-based artificial graphite and natural graphite such as spherical natural graphite.

Graphite has a low potential substantially equal to that of a lithium metal (0.1 V to 0.3 V vs. Li/Li⁺) when lithium ions are inserted into the graphite (when a lithium-graphite intercalation compound is formed). For this reason, a lithium ion battery can have a high operating voltage. In addition, graphite is preferable because of its advantages such as relatively high capacity per unit volume, small volume expansion, low cost, and safety greater than that of a lithium metal.

The negative electrode active material can be an alloy-based material which enables charge-discharge reaction by alloying and dealloying reaction with lithium. In the case where lithium ions are carrier ions, the alloy-based material is, for example, a material containing at least one of Mg, Ca, Al, Si, Ge, Sn, Pb, Sb, Bi, Ag, Au, Zn, Cd, Hg, In, and the like. Such elements have higher capacity than carbon. In particular, silicon has a significantly high theoretical capacity of 4200 mAh/g. For this reason, silicon is preferably used as the negative electrode active material. Examples of the alloy-based material using such elements include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn.

Alternatively, an oxide such as titanium dioxide (TiO₂), lithium titanium oxide (Li₄Ti₅O₁₂), lithium-graphite intercalation compound (LiₓC₆), niobium pentoxide (Nb₂O₅), tungsten oxide (WO₂), or molybdenum oxide (MoO₂) can be used as the negative electrode active material 6103.

Still alternatively, Li₃₋ₓMₓN (M=Co, Ni, or Cu) with a Li₃N structure, which is a nitride containing lithium and a transition metal, can be used as the negative electrode active material 6103. For example, Li_{2.6}Co_{0.4}N₃ is preferable because of its high charge and discharge capacity (900 mAh/g and 1890 mAh/cm³).

A nitride containing lithium and a transition metal is preferably used, in which case the negative electrode active material includes lithium ions and thus can be used in combination with a positive electrode active material that does not contain lithium ions, such as V₂O₅ or Cr₃O₈. Note that in the case where a positive electrode active material contains lithium ions, the lithium ions contained in the positive electrode active material are extracted in advance, so that the nitride containing lithium and a transition metal can be used as the negative electrode active material.

Alternatively, a material which causes a conversion reaction can be used as the negative electrode active material 6103; for example, a transition metal oxide which does not cause an alloy reaction with lithium, such as cobalt oxide (CoO), nickel oxide (NiO), or iron oxide (FeO), may be used. Other examples of the material which causes a conversion reaction include oxides such as Fe₂O₃, CuO, Cu₂O, RuO₂, and Cr₂O₃, sulfides such as CoS_{0.89}, NiS, or CuS, nitrides such as Zn₃N₂, Cu₃N, and Ge₃N₄, phosphides such as NiP₂, FeP₂, and CoP₃, and fluorides such as FeF₃ and BiF₃. Note that any of the fluorides can also be used as the positive electrode active material 6003 because of its high potential.

The shape of the negative electrode active material 6103 is not limited to that illustrated in FIG. 2B. The shape of the negative electrode active material 6103 may be a given shape such as a particle shape, a plate shape, a rod shape, a cylindrical shape, a powder shape, or a flake shape. Furthermore, the negative electrode active material 6103 may have a three-dimensional shape such as unevenness on a surface with a plate shape, fine unevenness on a surface, or a porous shape.

In the case where the negative electrode active material layer 6102 is formed by a coating method, the negative electrode active material 6103 and the binder 6105 are mixed to form a negative electrode paste (slurry), and the negative electrode paste is applied to the negative electrode current collector 6101 and dried. Note that a conductive additive may be added to the negative electrode paste.

Note that the negative electrode active material layer 6102 may be predoped with lithium. As a predoping method, a sputtering method may be performed to form a lithium layer on a surface of the negative electrode active material layer 6102. Alternatively, the negative electrode active material layer 6102 can be predoped with lithium by providing lithium foil on the surface thereof.

Furthermore, graphene may be formed on a surface of the negative electrode active material 6103. In the case of using silicon as the negative electrode active material 6103, the volume of silicon is greatly changed due to occlusion and release of carrier ions in charge-discharge cycles. Therefore, adhesion between the negative electrode current collector 6101 and the negative electrode active material layer 6102 is decreased, resulting in degradation of battery characteristics caused by charging and discharging. In view of this, graphene is preferably formed on a surface of the negative electrode active material 6103 containing silicon because even when the volume of silicon is changed in charge-discharge cycles, decrease in the adhesion between the negative electrode current collector 6101 and the negative electrode active material layer 6102 can be regulated, which makes it possible to reduce degradation of battery characteristics.

A coating film of oxide or the like may be formed on the surface of the negative electrode active material 6103. A coating film formed by decomposition of an electrolyte solution in charging cannot release electric charges used at the time of forming the coating film, and therefore forms irreversible capacity. In contrast, the coating film of oxide or the like provided on the surface of the negative electrode active material 6103 in advance can reduce or prevent generation of irreversible capacity.

As the coating film coating the negative electrode active material 6103, an oxide film of any one of niobium, titanium, vanadium, tantalum, tungsten, zirconium, molybdenum, hafnium, chromium, aluminum, and silicon or an oxide film containing any one of these elements and lithium can be used. The coating film is denser than a conventional coating film that is formed on a surface of a negative electrode by a decomposition product of an electrolyte solution.

For example, niobium oxide (Nb₂O₅) has a low electric conductivity of 10⁻⁹ S/cm² and a high insulating property. Hence, a niobium oxide film inhibits electrochemical decomposition reaction between the negative electrode active material and the electrolyte solution. On the other hand, niobium oxide has a lithium diffusion coefficient of 10⁻⁹ cm²/sec and a high lithium ion conductivity. Therefore, niobium oxide can transmit lithium ions.

A sol-gel method can be used to coat the negative electrode active material 6103 with the coating film, for example. The sol-gel method is a method for forming a thin film in such a manner that a solution of metal alkoxide, a metal salt, or the like is changed into a gel, which has lost its fluidity, by hydrolysis reaction and polycondensation reaction and the gel is baked. Since a thin film is formed from a liquid phase in the sol-gel method, raw materials can be mixed uniformly on the molecular scale. For this reason, by adding a negative electrode active material such as graphite to a raw material of the metal oxide film which is a solvent, the active material can be easily dispersed into the gel. In such a manner, the coating film can be formed on the surface of the negative electrode active material 6103. A decrease in the capacity of the power storage unit can be prevented by using the coating film.

The content of the binder 6105 in the negative electrode active material layer 6102 is preferably greater than or equal to 1 wt % and less than or equal to 10 wt %, more preferably greater than or equal to 2 wt % and less than or equal to 8 wt %, and still more preferably greater than or equal to 3 wt % and less than or equal to 5 wt %. In the case where a conductive additive is added to the negative electrode active material layer 6102, the content of the conductive additive in the negative electrode active material layer 6102 is preferably greater than or equal to 1 wt % and less than or equal to 10 wt %, more preferably greater than or equal to 1 wt % and less than or equal to 5 wt %.

### [3. Electrolyte Solution]

As a solvent of an electrolyte solution used for the power storage unit, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

The use of a gelled high-molecular material as the solvent of the electrolyte solution improves the safety against liquid leakage and the like. In addition, the power storage unit can be made thinner and more lightweight. Typical examples of gelled high-molecular materials include a silicone gel, an acrylic gel, an acrylonitrile gel, polyethylene oxide, polypropylene oxide, and a fluorine-based polymer.

Alternatively, the use of one or more ionic liquids (room temperature molten salts) which are less likely to burn and volatilize as the solvent of the electrolyte solution can prevent the power storage unit from exploding or catching fire even when the power storage unit internally shorts out or the internal temperature increases due to overcharging or the like.

In the case of using lithium ions as carriers, for example, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), and LiN(C₂F₅SO₂)₂ can be used as an electrolyte dissolved in the above solvent, or two or more of these lithium salts can be used in an appropriate combination in an appropriate ratio.

The electrolyte solution used for the power storage unit preferably contains a small amount of dust particles and elements other than the constituent elements of the electrolyte solution (hereinafter, also simply referred to as impurities) so as to be highly purified. Specifically, the weight ratio of impurities to the electrolyte solution is less than or equal to 1%, preferably less than or equal to 0.1%, and more preferably less than or equal to 0.01%. An additive agent such as vinylene carbonate may be added to the electrolyte solution.

### [4. Separator]

As a separator of the power storage unit, a porous insulator such as cellulose, polypropylene (PP), polyethylene (PE), polybutene, nylon, polyester, polysulfone, polyacrylonitrile, polyvinylidene fluoride, or tetrafluoroethylene can be used. Alternatively, nonwoven fabric of a glass fiber or the like, or a diaphragm in which a glass fiber and a polymer fiber are mixed may be used.

This embodiment can be implemented in appropriate combination with any of the other embodiments and example.

### Embodiment 2

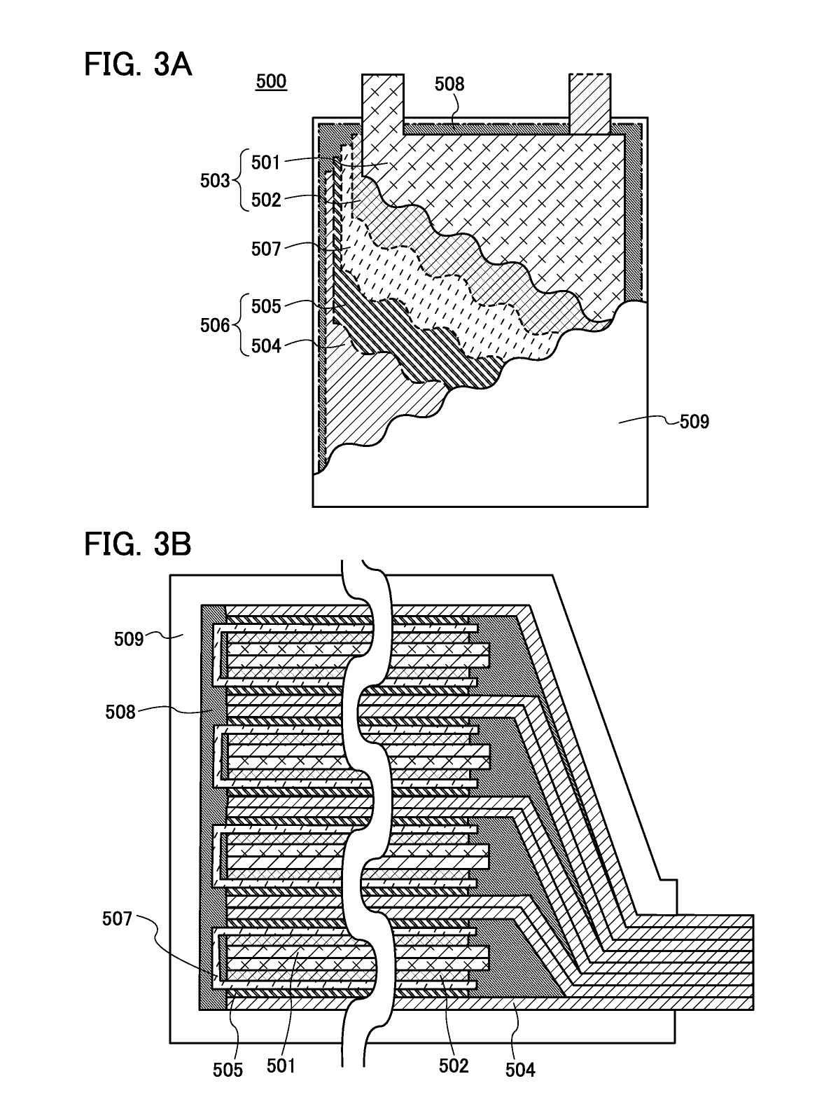

In this embodiment, an example of a laminated power storage unit will be described with reference to FIG. 3A. When the laminated power storage unit has flexibility, it can be easily attached to a curved surface. Furthermore, when the flexible laminated power storage unit is used in an electronic device at least part of which is flexible, the power storage unit can be bent as the electronic device is bent.

A laminated power storage unit 500 illustrated in FIG. 3A includes a positive electrode 503 provided with a positive electrode current collector 501 and a positive electrode active material layer 502, a negative electrode 506 provided with a negative electrode current collector 504 and a negative electrode active material layer 505, a separator 507, an electrolyte solution 508, and an exterior body 509. The separator 507 is provided between the positive electrode 503 and the negative electrode 506 in the exterior body 509. The exterior body 509 is filled with the electrolyte solution 508.

In the laminated power storage unit 500 illustrated in FIG. 3A, the positive electrode current collector 501 and the negative electrode current collector 504 also serve as terminals for an electrical contact with an external portion. Therefore, each of the positive electrode current collector 501 and the negative electrode current collector 504 may be arranged so as to be partly exposed to the outside of the exterior body 509. Alternatively, a lead electrode and the positive electrode current collector 501 or the negative electrode current collector 504 may be bonded to each other by ultrasonic welding, and instead of the positive electrode current collector 501 and the negative electrode current collector 504, the lead electrode may be exposed to the outside of the exterior body 509.

The exterior body 509 in the laminated power storage unit 500 can be formed using, for example, a laminate film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided as the outer surface of the exterior body over the metal thin film.

FIG. 3B illustrates an example of the cross-sectional structure of the laminated power storage unit 500. Although only two current collectors are provided in FIG. 3A for simplicity, the actual battery includes more electrode layers.

In FIG. 3B, 16 electrode layers are provided as an example. The laminated power storage unit 500 has flexibility even though including 16 electrode layers. FIG. 3B illustrates a structure including 8 negative electrode current collectors 504 and 8 positive electrode current collectors 501. Note that FIG. 3B illustrates a cross section of the lead portion of the negative electrode, and the 8 negative electrode current collectors 504 are bonded to each other by ultrasonic welding. It is needless to say that the number of electrode layers is not limited to 16, and may be more than 16 or less than 16. The power storage unit can have higher capacity with a larger number of electrode layers. In contrast, with a smaller number of electrode layers, the power storage unit can have a smaller thickness and higher flexibility.

Note that the laminated power storage unit is shown in this embodiment; however, one embodiment of the present invention can be used for power storage units with a variety of shapes, such as a coin-type power storage unit, a cylindrical power storage unit, a sealed power storage unit, and a square power storage unit. It is also possible to employ a structure in which a plurality of positive electrodes, a plurality of negative electrodes, and a plurality of separators are stacked or wound.

The positive electrode 503 and the negative electrode 506 can be manufactured in a manner similar to that of the positive electrode 6000 and the negative electrode 6100 shown in the above embodiment, respectively. The use of the positive electrode and the negative electrode shown in the above embodiment achieves a power storage unit that can be repeatedly bent without a large decrease in charge and discharge capacity.

This embodiment can be implemented in appropriate combination with any of the other embodiments and example.

### Embodiment 3

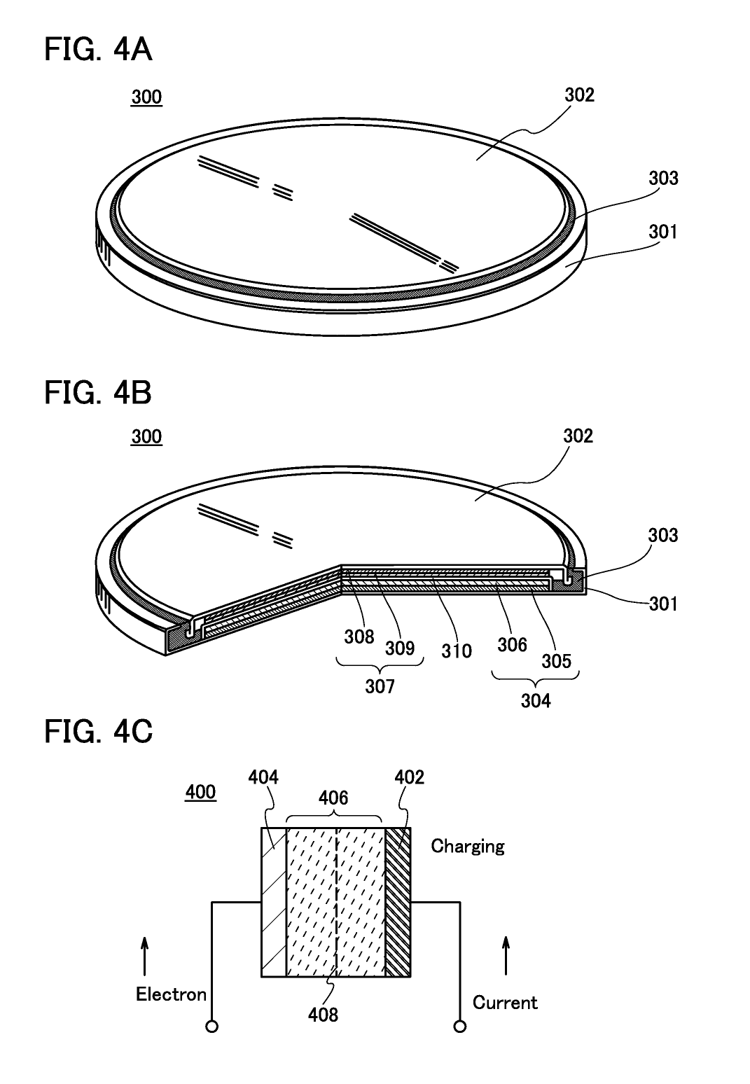

In this embodiment, an example of a coin-type power storage unit will be described with reference to FIG. 4A. When the coin-type power storage unit has flexibility, it can be easily attached to a curved surface. Furthermore, when the coin-type power storage unit is used in an electronic device at least part of which is flexible, the power storage unit can be bent as the electronic device is bent.

FIG. 4A is an external view of a coin-type (single-layer flat type) power storage unit, and FIG. 4B is a cross-sectional view thereof.

In a coin-type power storage unit 300, an exterior body 301 serving as a positive electrode terminal and an exterior body 302 serving as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. The positive electrode 304 can be manufactured in a manner similar to that of the positive electrode 6000 shown in Embodiment 1.

A negative electrode 307 includes a negative electrode current collector 308 and a negative electrode active material layer 309 provided in contact with the negative electrode current collector 308. The negative electrode 307 can be manufactured in a manner similar to that of the negative electrode 6100 shown in Embodiment 1. A separator 310 and an electrolyte (not illustrated) are provided between the positive electrode active material layer 306 and the negative electrode active material layer 309.

The use of the positive electrode and the negative electrode shown in Embodiment 1 achieves a coin-type power storage unit that can be repeatedly bent without a large decrease in charge and discharge capacity.

The exterior bodies 301 and 302 can be formed using a metal having corrosion resistance to an electrolyte solution, such as nickel, aluminum, or titanium, an alloy of such a metal, or an alloy of such a metal and another metal (e.g., stainless steel). Alternatively, the exterior bodies 301 and 302 are preferably covered with nickel, aluminum, or the like in order to prevent corrosion caused by the electrolyte solution. The exterior body 301 and the exterior body 302 are electrically connected to the positive electrode 304 and the negative electrode 307, respectively.

The negative electrode 307, the positive electrode 304, and the separator 310 are immersed in the electrolyte solution. Then, as illustrated in FIG. 4B, the exterior body 301, the positive electrode 304, the separator 310, the negative electrode 307, and the exterior body 302 are stacked in this order, and the exterior body 301 and the exterior body 302 are subjected to pressure bonding with the gasket 303 interposed therebetween. In such a manner, the coin-type power storage unit 300 having flexibility can be manufactured.

Here, a current flow in charging a battery is described with reference to FIG. 4C. When a battery using lithium is regarded as a closed circuit, lithium ions and current move in the same direction. Note that in the battery using lithium, an anode and a cathode change places in charge and discharge, and an oxidation reaction and a reduction reaction occur on the corresponding sides; hence, an electrode with a high redox potential is called a positive electrode and an electrode with a low redox potential is called a negative electrode. For this reason, in this specification, the positive electrode is referred to as a “positive electrode” and the negative electrode is referred to as a “negative electrode” in all the cases where charge is performed and discharge is performed. The use of the terms “anode” and “cathode” related to an oxidation reaction and a reduction reaction might cause confusion because the anode and the cathode change places at the time of charging and discharging. Thus, the terms “anode” and “cathode” are not used in this specification. If the term “anode” or “cathode” is used, it should be mentioned that the anode or the cathode is which of the one at the time of charging or the one at the time of discharging and corresponds to which of a positive electrode or a negative electrode.

A power storage unit 400 illustrated in FIG. 4C includes a positive electrode 402, a negative electrode 404, an electrolyte solution 406, and a separator 408. The positive electrode 402 and the negative electrode 404 are connected to their respective terminals which are connected to a charger, whereby the power storage unit 400 is charged. As the charge of the power storage unit 400 proceeds, a potential difference between the positive electrode 402 and the negative electrode 404 increases. The positive direction in FIG. 4C is the direction in which a current flows from one terminal outside the power storage unit 400 to the positive electrode 402, flows from the positive electrode 402 to the negative electrode 404 in the power storage unit 400, and flows from the negative electrode 404 to the other terminal outside the power storage unit 400. In other words, a current flows in the direction of a charging current.

This embodiment can be implemented in appropriate combination with any of the other embodiments and example.

### Embodiment 4

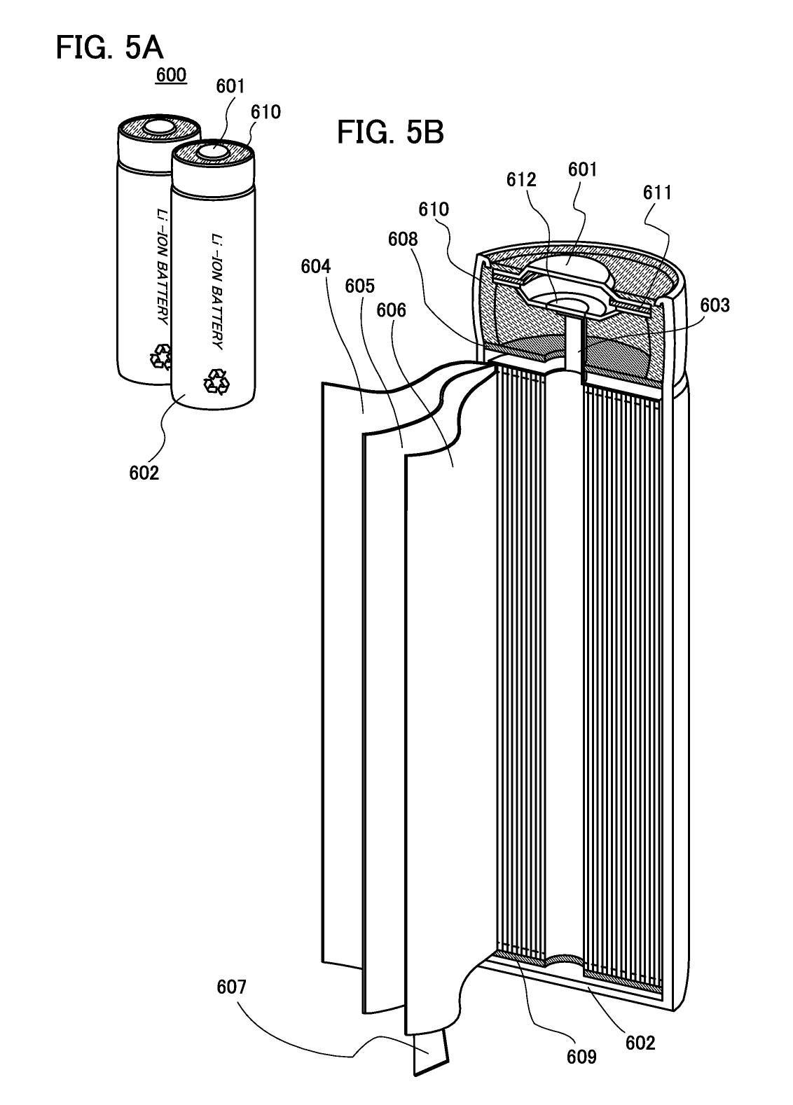

In this embodiment, an example of a cylindrical power storage unit will be described with reference to FIGS. 5A and 5B. When the cylindrical power storage unit has flexibility, it can be easily attached to a curved surface. Furthermore, when the flexible cylindrical power storage unit is used in an electronic device at least part of which is flexible, the power storage unit can be bent as the electronic device is bent.

As illustrated in FIG. 5A, a cylindrical power storage unit 600 includes a positive electrode cap (battery cap) 601 on the top surface and an exterior body 602 on the side and bottom surface. The positive electrode cap 601 and the exterior body 602 are insulated from each other by a gasket (insulating gasket) 610.

FIG. 5B schematically illustrates a cross section of the cylindrical power storage unit. Inside the exterior body 602 having a hollow cylindrical shape, a battery element in which a strip-like positive electrode 604 and a strip-like negative electrode 606 are wound with a stripe-like separator 605 interposed therebetween is provided. Although not illustrated, the battery element is wound around a center pin. One end of the exterior body 602 is close and the other end thereof is open. The exterior body 602 can be formed using a metal having corrosion resistance to an electrolyte solution, such as nickel, aluminum, or titanium, an alloy of such a metal, or an alloy of such a metal and another metal (e.g., stainless steel). Alternatively, the exterior body 602 is preferably covered with nickel, aluminum, or the like in order to prevent corrosion caused by an electrolyte solution. Inside the exterior body 602, the battery element in which the positive electrode, the negative electrode, and the separator are wound is interposed between a pair of insulating plates 608 and 609 which face each other. Furthermore, a nonaqueous electrolyte solution (not illustrated) is injected inside the exterior body 602 provided with the battery element. The nonaqueous electrolyte solution can be similar to that in the above coin-type power storage unit.

The positive electrode 604 and the negative electrode 606 can be manufactured in a manner similar to that of the positive electrode 6000 and the negative electrode 6100 shown in Embodiment 1, respectively. The use of the positive electrode and the negative electrode shown in Embodiment 1 achieves a cylindrical power storage unit that can be repeatedly bent without a large decrease in charge and discharge capacity.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 612 and the bottom of the exterior body 602, respectively. The safety valve mechanism 612 is electrically connected to the positive electrode cap 601 through a positive temperature coefficient (PTC) element 611. The safety valve mechanism 612 cuts off electrical connection between the positive electrode cap 601 and the positive electrode 604 when the internal pressure of the battery exceeds a predetermined threshold value. The PTC element 611, which serves as a thermally sensitive resistor whose resistance increases as temperature rises, limits the amount of current by increasing the resistance, in order to prevent abnormal heat generation. Note that barium titanate (BaTiO₃)-based semiconductor ceramic can be used for the PTC element.

This embodiment can be implemented in appropriate combination with any of the other embodiments and example.

### Embodiment 5

In this embodiment, examples of a structure of a power storage device (storage battery) will be described with reference to FIGS. 6A and 6B, FIGS. 7A-1 to 7B-2, FIGS. 8A and 8B, FIGS. 9A and 9B, and FIG. 10. When the power storage device has flexibility, it can be easily attached to a curved surface. Furthermore, when the flexible power storage device is used in an electronic device at least part of which is flexible, the power storage device can be bent as the electronic device is bent. Note that in this specification and the like, the power storage device includes at least the power storage unit of one embodiment of the present invention.

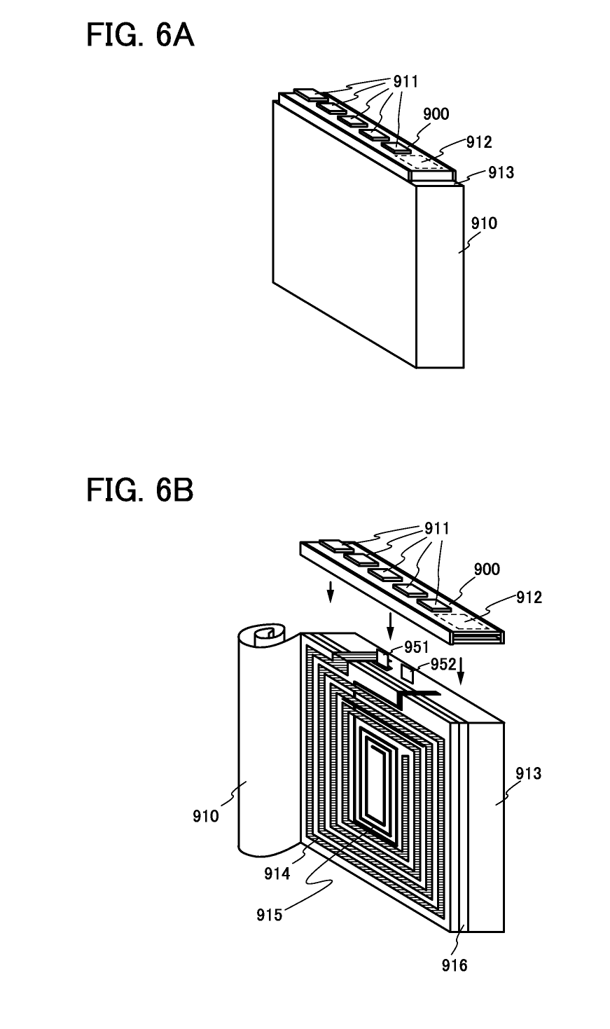

FIGS. 6A and 6B are external views of the power storage device. The power storage device in FIGS. 6A and 6B includes a circuit board 900 and a power storage unit 913. A label 910 is attached to the power storage unit 913. Furthermore, as illustrated in FIG. 6B, the power storage device includes a terminal 951 and a terminal 952, and includes an antenna 914 and an antenna 915 between the power storage unit 913 and the label 910.

The circuit board 900 includes terminals 911 and a circuit 912. The terminals 911 are connected to the terminals 951 and 952, the antennas 914 and 915, and the circuit 912. Note that a plurality of terminals 911 serving as a control signal input terminal, a power supply terminal, and the like may be provided.

The circuit 912 may be provided on the rear side of the circuit board 900. Note that each of the antennas 914 and 915 is not limited to having a coil shape and may have a linear shape or a plate shape. Alternatively, a planar antenna, an aperture antenna, a traveling-wave antenna, an EH antenna, a magnetic-field antenna, or a dielectric antenna may be used. Further alternatively, the antenna 914 or the antenna 915 may be a flat-plate conductor. The flat-plate conductor can serve as one of conductors for electric field coupling. That is, the antenna 914 or the antenna 915 can serve as one of two conductors of a capacitor. Thus, power can be transmitted and received not only by an electromagnetic field or a magnetic field but also by an electric field.

The line width of the antenna 914 is preferably larger than that of the antenna 915. This makes it possible to increase the amount of electric power received by the antenna 914.

The power storage device includes a layer 916 between the power storage unit 913 and the antennas 914 and 915. The layer 916 has a function of preventing the power storage unit 913 from shielding an electromagnetic field. As the layer 916, for example, a magnetic body can be used. The layer 916 may serve as a shielding layer.

Note that the structure of the power storage device is not limited to that illustrated in FIGS. 6A and 6B.

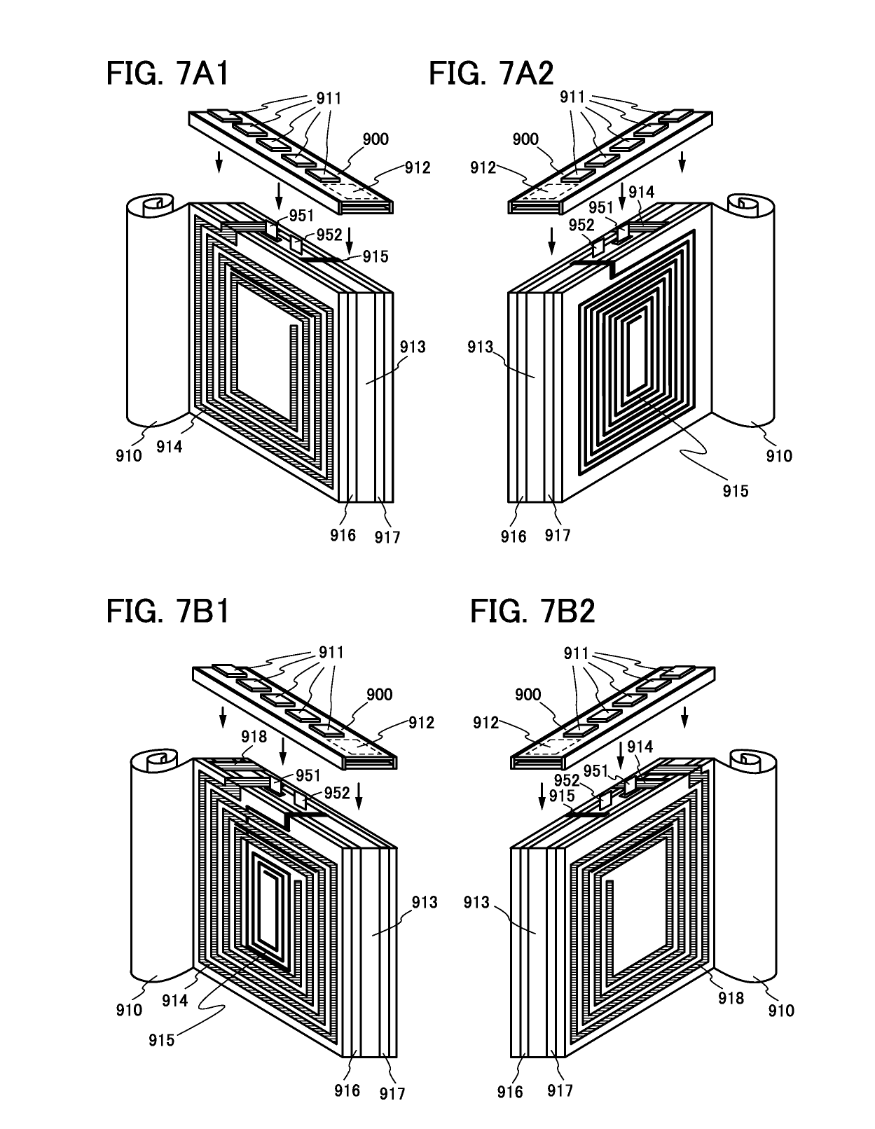

For example, as illustrated in FIGS. 7A-1 and 7A-2, two opposing surfaces of the power storage unit 913 in FIGS. 6A and 6B may be provided with their respective antennas. FIG. 7A-1 is an external view showing one side of the opposing surfaces, and FIG. 7A-2 is an external view showing the other side of the opposing surfaces. Note that for portions similar to those in FIGS. 6A and 6B, description on the power storage device shown in FIGS. 6A and 6B can be referred to as appropriate.

As illustrated in FIG. 7A-1, the antenna 914 is provided on one of the opposing surfaces of the power storage unit 913 with the layer 916 provided therebetween, and as illustrated in FIG. 7A-2, the antenna 915 is provided on the other of the opposing surfaces of the power storage unit 913 with a layer 917 provided therebetween. The layer 917 has a function of preventing the power storage unit 913 from shielding an electromagnetic field. As the layer 917, for example, a magnetic body can be used. The layer 917 may serve as a shielding layer.

With the above structure, both of the antennas 914 and 915 can be increased in size.

Alternatively, as illustrated in FIGS. 7B-1 and 7B-2, two opposing surfaces of the power storage unit 913 in FIGS. 6A and 6B may be provided with different types of antennas. FIG. 7B-1 is an external view showing one side of the opposing surfaces, and FIG. 7B-2 is an external view showing the other side of the opposing surfaces. Note that for portions similar to those in FIGS. 6A and 6B, description on the power storage device shown in FIGS. 6A and 6B can be referred to as appropriate.

As illustrated in FIG. 7B-1, the antennas 914 and 915 are provided on one of the opposing surfaces of the power storage unit 913 with the layer 916 provided therebetween, and as illustrated in FIG. 7B-2, an antenna 918 is provided on the other of the opposing surfaces of the power storage unit 913 with the layer 917 provided therebetween. The antenna 918 has a function of performing data communication with an external device, for example. An antenna with a shape that can be applied to the antennas 914 and 915, for example, can be used as the antenna 918. As a system for communication using the antenna 918 between the power storage device and another device, a response method which can be used between the power storage device and another device, such as NFC, can be employed.

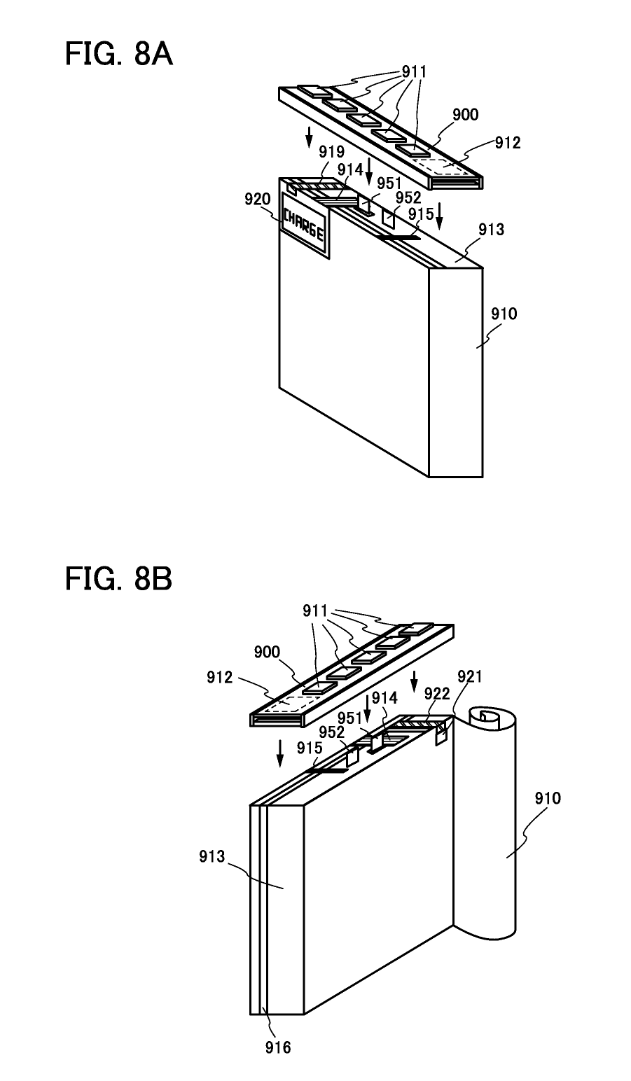

Alternatively, as illustrated in FIG. 8A, the power storage unit 913 in FIGS. 6A and 6B may be provided with a display device 920. The display device 920 is electrically connected to the terminal 911 via a terminal 919. It is possible that the label 910 is not provided in a portion where the display device 920 is provided. Note that for portions similar to those in FIGS. 6A and 6B, description on the power storage device shown in FIGS. 6A and 6B can be referred to as appropriate.

The display device 920 can display, for example, an image showing whether or not charging is being carried out, or an image showing the amount of stored power. As the display device 920, electronic paper, a liquid crystal display device, an electroluminescent (EL) display device, or the like can be used. For example, the power consumption of the display device 920 can be reduced when electronic paper is used.

Alternatively, as illustrated in FIG. 8B, the power storage unit 913 in FIGS. 6A and 6B may be provided with a sensor 921. The sensor 921 is electrically connected to the terminal 911 via a terminal 922. Note that the sensor 921 may be provided between the power storage unit 913 and the label 910. Note that for portions similar to those in FIGS. 6A and 6B, description on the power storage device shown in FIGS. 6A and 6B can be referred to as appropriate.

The sensor 921 has a function of measuring displacement, position, speed, acceleration, angular velocity, rotational frequency, distance, light, liquid, magnetism, temperature, chemical substance, sound, time, hardness, electric field, electric current, voltage, electric power, radiation, flow rate, humidity, gradient, oscillation, odor, or infrared rays. With the sensor 921, for example, data on an environment (e.g., temperature) where the power storage device is placed can be detected and stored in a memory inside the circuit 912.

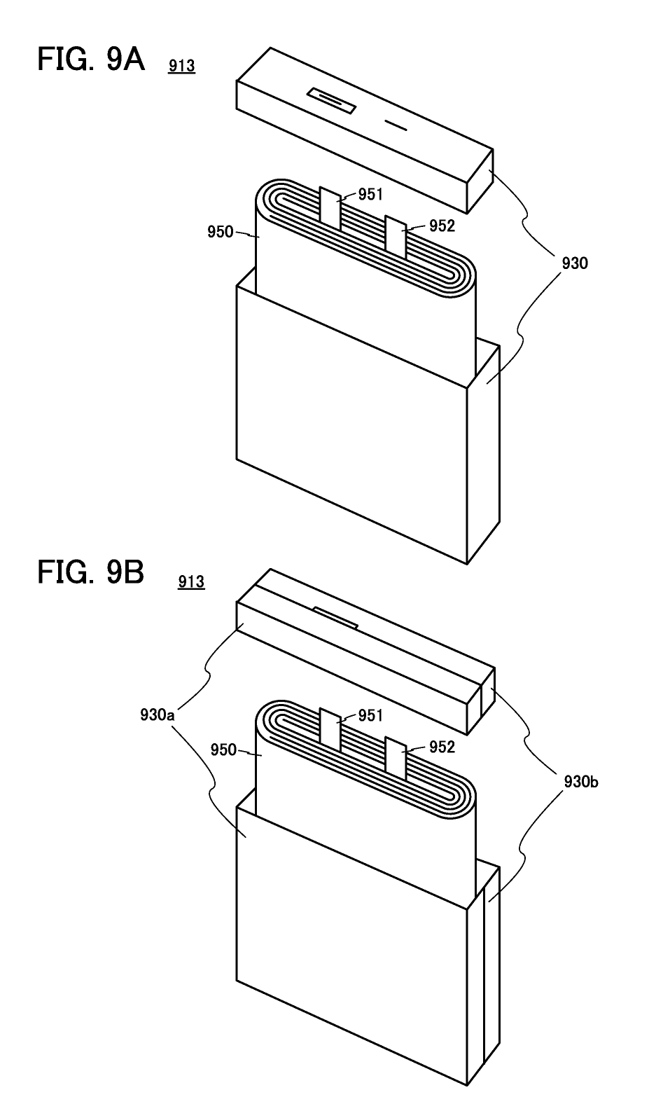

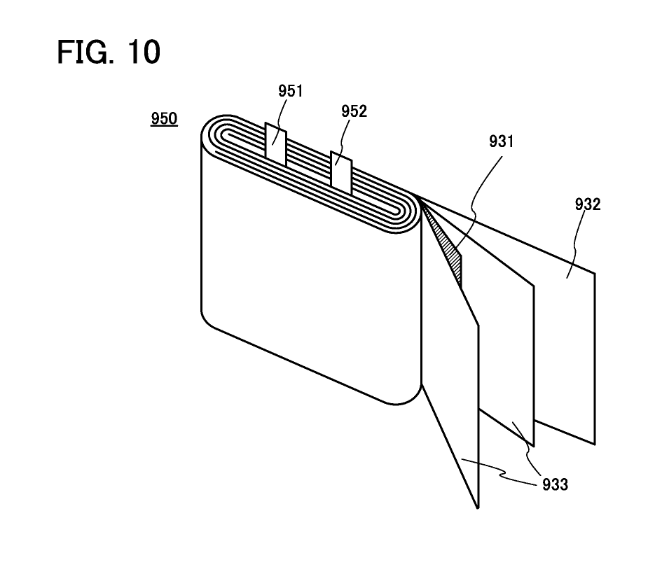

Examples of a structure of the power storage unit 913 will be described with reference to FIGS. 9A and 9B and FIG. 10.

The power storage unit 913 illustrated in FIG. 9A includes a wound body 950 provided with the terminals 951 and 952 inside a housing 930. The wound body 950 is soaked in an electrolyte solution inside the housing 930. The terminal 952 is in contact with the housing 930. An insulator or the like prevents contact between the terminal 951 and the housing 930. Note that FIG. 9A illustrates the housing 930 divided into two pieces for convenience; however, in the actual structure, the wound body 950 is covered with the housing 930 and the terminals 951 and 952 extend to the outside of the housing 930. For the housing 930, a metal material (e.g., aluminum) or a resin material can be used.

Note that as illustrated in FIG. 9B, the housing 930 in FIG. 9A may be formed using a plurality of materials. For example, in the power storage unit 913 in FIG. 9B, a housing 930a and a housing 930b are attached to each other and the wound body 950 is provided in a region surrounded by the housing 930a and the housing 930b.

For the housing 930a, an insulating material such as an organic resin can be used. In particular, when a material such as an organic resin is used for the side on which an antenna is formed, shielding of the electric field by the power storage unit 913 can be prevented. Note that an antenna such as the antennas 914 and 915 may be provided inside the housing 930a if the electric field is not completely shielded by the housing 930a. For the housing 930b, a metal material can be used, for example.

FIG. 10 illustrates a structure of the wound body 950. The wound body 950 includes a negative electrode 931, a positive electrode 932, and a separator 933. The wound body 950 is obtained by winding a layered sheet in which the negative electrode 931 overlaps with the positive electrode 932 with the separator 933 provided therebetween. Note that a plurality of layers each including the negative electrode 931, the positive electrode 932, and the separator 933 may be stacked.

The negative electrode 931 is connected to the terminal 911 in FIGS. 6A and 6B via one of the terminals 951 and 952. The positive electrode 932 is connected to the terminal 911 in FIGS. 6A and 6B via the other of the terminals 951 and 952.

This embodiment can be implemented in appropriate combination with any of the other embodiments and example.

### Embodiment 6

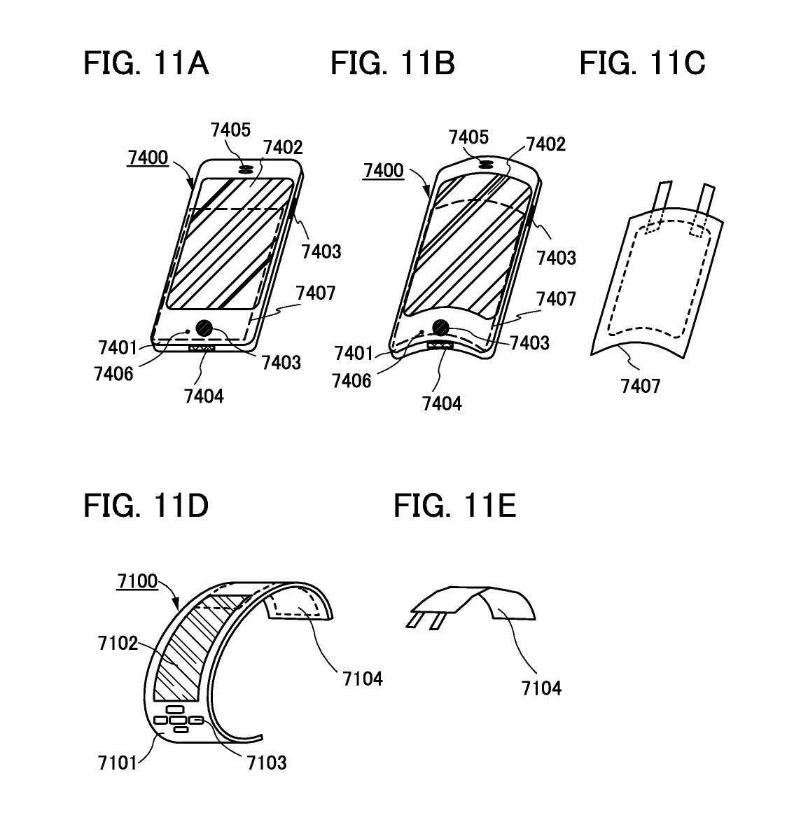

The power storage unit of one embodiment of the present invention can be used as a power source of various electronic devices which are driven by electric power. FIGS. 11A to 11E, FIGS. 12A to 12C, FIG. 13, and FIGS. 14A and 14B illustrate specific examples of the electronic devices using the power storage unit of one embodiment of the present invention.

Specific examples of the electronic devices using the power storage unit of one embodiment of the present invention are as follows: display devices of televisions, monitors, and the like, lighting devices, desktop and laptop personal computers, word processors, image reproduction devices which reproduce still images and moving images stored in recording media such as digital versatile discs (DVDs), portable CD players, radios, tape recorders, headphone stereos, stereos, table clocks, wall clocks, cordless phone handsets, transceivers, mobile phones, car phones, portable game machines, tablet terminals, large game machines such as pachinko machines, calculators, portable information terminals, electronic notebooks, e-book readers, electronic translators, audio input devices, video cameras, digital still cameras, electric shavers, high-frequency heating appliances such as microwave ovens, electric rice cookers, electric washing machines, electric vacuum cleaners, water heaters, electric fans, hair dryers, air-conditioning systems such as air conditioners, humidifiers, and dehumidifiers, dishwashers, dish dryers, clothes dryers, futon dryers, electric refrigerators, electric freezers, electric refrigerator-freezers, freezers for preserving DNA, flashlights, electrical tools such as a chain saw, smoke detectors, and medical equipment such as dialyzers. Other examples are as follows: industrial equipment such as guide lights, traffic lights, belt conveyors, elevators, escalators, industrial robots, power storage systems, and power storage devices for leveling the amount of power supply and smart grid. In addition, moving objects and the like driven by fuel engines and electric motors using power from non-aqueous secondary batteries are also included in the category of electronic devices. Examples of the moving objects include electric vehicles (EV), hybrid electric vehicles (HEV) which include both an internal-combustion engine and a motor, plug-in hybrid electric vehicles (PHEV), tracked vehicles in which caterpillar tracks are substituted for wheels of these vehicles, motorized bicycles including motor-assisted bicycles, motorcycles, electric wheelchairs, golf carts, boats, ships, submarines, helicopters, aircrafts, rockets, artificial satellites, space probes, planetary probes, and spacecrafts.

In addition, the power storage unit of one embodiment of the present invention can be incorporated along a curved inside/outside wall surface of a house or a building or a curved interior/exterior surface of a car.

FIG. 11A illustrates an example of a mobile phone. A mobile phone 7400 includes a display portion 7402 incorporated in a housing 7401, an operation button 7403, an external connection port 7404, a speaker 7405, a microphone 7406, and the like. Note that the mobile phone 7400 includes a power storage device 7407.

The mobile phone 7400 illustrated in FIG. 11B is bent. When the whole mobile phone 7400 is bent by the external force, the power storage device 7407 included in the mobile phone 7400 is also bent. FIG. 11C illustrates the bent power storage device 7407. The power storage device 7407 is a laminated power storage unit.

FIG. 11D illustrates an example of a bangle display device. A portable display device 7100 includes a housing 7101, a display portion 7102, an operation button 7103, and a power storage device 7104. FIG. 11E illustrates the bent power storage device 7104.

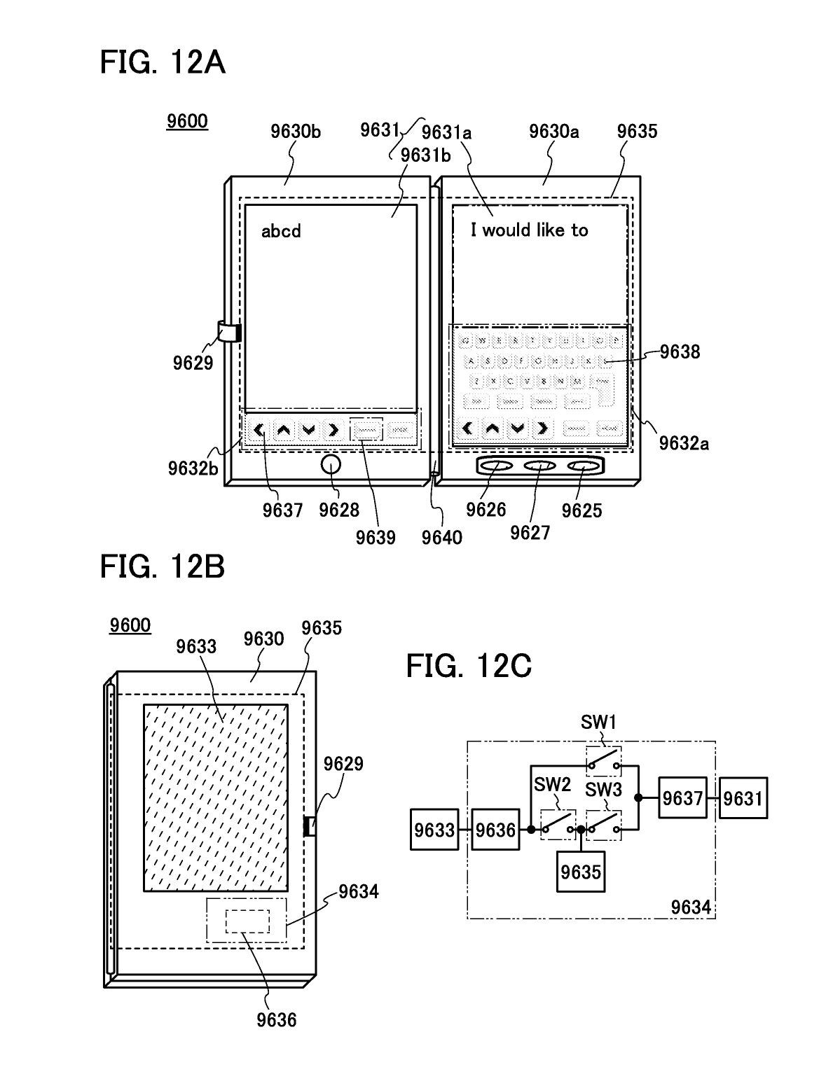

FIGS. 12A and 12B illustrate an example of a foldable tablet terminal. A tablet terminal 9600 illustrated in FIGS. 12A and 12B includes a housing 9630 provided with a housing 9630a and a housing 9630b, a movable portion 9640 connecting the housings 9630a and 9630b, a display portion 9631 provided with a display portion 9631a and a display portion 9631b, a display mode switch 9626, a power switch 9627, a power saver switch 9625, a fastener 9629, and an operation switch 9628. FIGS. 12A and 12B illustrate the tablet terminal 9600 opened and closed, respectively.

The tablet terminal 9600 includes a power storage unit 9635 inside the housings 9630a and 9630b. The power storage unit 9635 is provided across the housings 9630a and 9630b, passing through the movable portion 9640.

Part of the display portion 9631a can be a touch panel region 9632a and data can be input when a displayed operation key 9638 is touched. FIG. 12A shows, but is not limited to, a structure in which a half region in the display portion 9631a has only a display function and the other half region has a touch panel function. The whole area of the display portion 9631a may have a touch panel function. For example, the whole area of the display portion 9631a can display keyboard buttons and serve as a touch panel while the display portion 9631b can be used as a display screen.

As in the display portion 9631a, part of the display portion 9631b can be a touch panel region 9632b. When a keyboard display switching button 9639 displayed on the touch panel is touched with a finger, a stylus, or the like, a keyboard can be displayed on the display portion 9631b.

Touch input can be performed in the touch panel region 9632a and the touch panel region 9632b at the same time.

The display mode switch 9626 can switch the display between portrait mode, landscape mode, and the like, and between monochrome display and color display, for example. The power saver switch 9625 can control display luminance in accordance with the amount of external light in use of the tablet terminal 9600, which is measured with an optical sensor incorporated in the tablet terminal 9600. The tablet terminal may include another detection device such as a gyroscope or an acceleration sensor in addition to the optical sensor.

FIG. 12A illustrates, but is not limited to, an example in which the display portions 9631a and 9631b have the same display area. The display portions 9631a and 9631b may have different display areas and different display quality. For example, higher-resolution images may be displayed on one of the display portions 9631a and 9631b.

The tablet terminal is closed in FIG. 12B. The tablet terminal includes the housing 9630, a solar cell 9633, and a charge and discharge control circuit 9634 including a DCDC converter 9636. The power storage unit of one embodiment of the present invention is used as the power storage unit 9635.

The tablet terminal 9600 can be folded so that the housings 9630a and 9630b overlap with each other when not in use. Thus, the display portions 9631a and 9631b can be protected, which increases the durability of the tablet terminal 9600. In addition, the power storage unit 9635 of one embodiment of the present invention has flexibility and can be repeatedly bent without a large decrease in charge and discharge capacity. Thus, a highly reliable tablet terminal can be provided.

The tablet terminal illustrated in FIGS. 12A and 12B can also have a function of displaying various kinds of data (e.g., a still image, a moving image, and a text image), a function of displaying a calendar, a date, or the time on the display portion, a touch-input function of operating or editing data displayed on the display portion by touch input, a function of controlling processing by various kinds of software (programs), and the like.

The solar cell 9633, which is attached on the surface of the tablet terminal, supplies electric power to a touch panel, a display portion, an image signal processor, and the like. Note that the solar cell 9633 can be provided on one or both surfaces of the housing 9630 and the power storage unit 9635 can be charged efficiently. The use of a lithium-ion battery as the power storage unit 9635 brings an advantage such as a reduction in size.

The structure and operation of the charge and discharge control circuit 9634 in FIG. 12B are described with reference to a block diagram in FIG. 12C. The solar cell 9633, the power storage unit 9635, the DCDC converter 9636, a converter 9637, switches SW1 to SW3, and the display portion 9631 are illustrated in FIG. 12C, and the power storage unit 9635, the DCDC converter 9636, the converter 9637, and the switches SW1 to SW3 correspond to the charge and discharge control circuit 9634 in FIG. 12B.

First, an example of the operation in the case where electric power is generated by the solar cell 9633 using external light is described. The voltage of electric power generated by the solar cell is raised or lowered by the DCDC converter 9636 to a voltage for charging the power storage unit 9635. Then, when the electric power from the solar cell 9633 is used for the operation of the display portion 9631, the switch SW1 is turned on and the voltage of the electric power is raised or lowered by the converter 9637 to a voltage needed for the display portion 9631. When display on the display portion 9631 is not performed, the switch SW1 is turned off and the switch SW2 is turned on, so that the power storage unit 9635 can be charged.

Note that the solar cell 9633 is described as an example of a power generation means; however, one embodiment of the present invention is not limited to this example. The power storage unit 9635 may be charged using another power generation means such as a piezoelectric element or a thermoelectric conversion element (Peltier element). For example, the power storage unit 9635 may be charged using a non-contact power transmission module that transmits and receives electric power wirelessly (without contact) or using another charging means in combination.

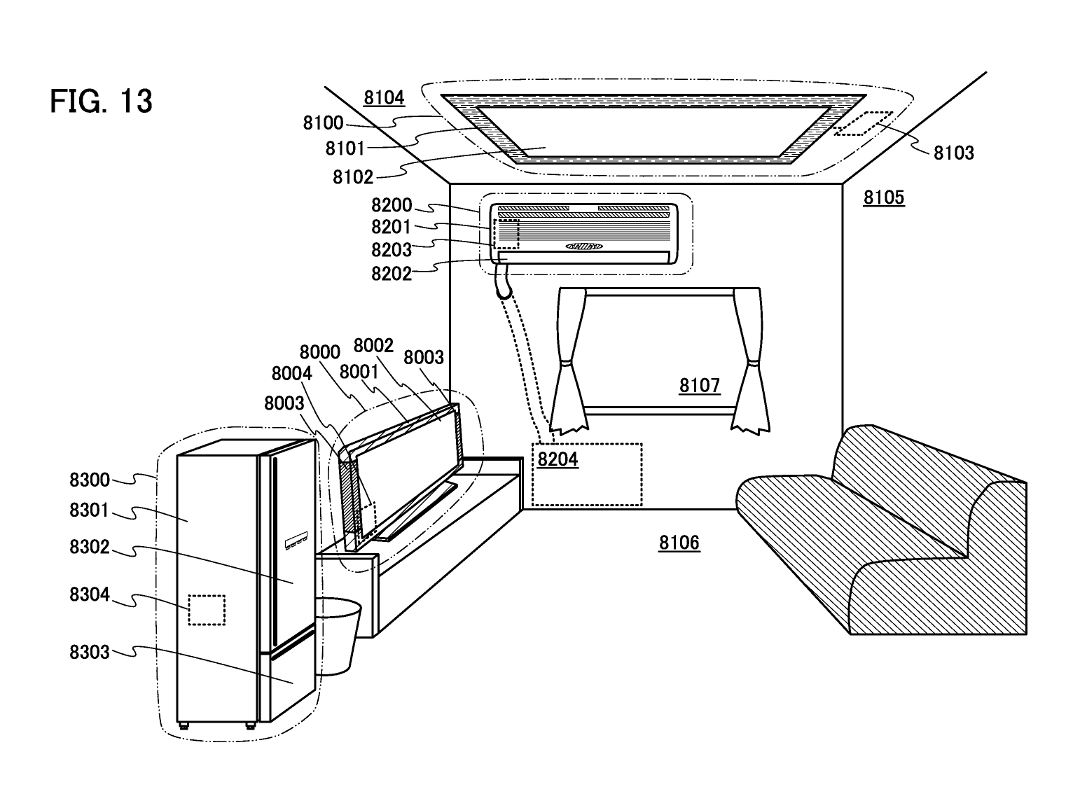

FIG. 13 illustrates examples of other electronic devices. In FIG. 13, a display device 8000 is an example of an electronic device including a power storage device 8004 of one embodiment of the present invention. Specifically, the display device 8000 corresponds to a display device for TV broadcast reception and includes a housing 8001, a display portion 8002, speaker portions 8003, the power storage device 8004, and the like. The power storage device 8004 of one embodiment of the present invention is provided in the housing 8001. The display device 8000 can receive electric power from a commercial power source or use electric power stored in the power storage device 8004. Thus, the display device 8000 can operate with the use of the power storage device 8004 of one embodiment of the present invention as an uninterruptible power source even when electric power cannot be supplied from a commercial power source because of power failure or the like.

A semiconductor display device such as a liquid crystal display device, a light-emitting device in which a light-emitting element such as an organic EL element is provided in each pixel, an electrophoresis display device, a digital micromirror device (DMD), a plasma display panel (PDP), or a field emission display (FED) can be used for the display portion 8002.

Note that the display device includes, in its category, all information display devices for personal computers, advertisement displays, and the like besides the ones for TV broadcast reception.

In FIG. 13, an installation lighting device 8100 is an example of an electronic device including a power storage device 8103 of one embodiment of the present invention. Specifically, the lighting device 8100 includes a housing 8101, a light source 8102, the power storage device 8103, and the like. Although FIG. 13 illustrates the case where the power storage device 8103 is provided in a ceiling 8104 on which the housing 8101 and the light source 8102 are installed, the power storage device 8103 may be provided in the housing 8101. The lighting device 8100 can receive electric power from a commercial power source or use electric power stored in the power storage device 8103. Thus, the lighting device 8100 can operate with the use of the power storage device 8103 of one embodiment of the present invention as an uninterruptible power source even when electric power cannot be supplied from a commercial power source because of power failure or the like.

Note that although the installation lighting device 8100 provided in the ceiling 8104 is illustrated in FIG. 13 as an example, the power storage device of one embodiment of the present invention can be used in an installation lighting device provided in, for example, a wall 8105, a floor 8106, a window 8107, or the like besides the ceiling 8104. Alternatively, the power storage device can be used in a tabletop lighting device or the like.

As the light source 8102, an artificial light source which emits light artificially by using electric power can be used. Specifically, an incandescent lamp, a discharge lamp such as a fluorescent lamp, and light-emitting elements such as an LED and an organic EL element are given as examples of the artificial light source.

In FIG. 13, an air conditioner including an indoor unit 8200 and an outdoor unit 8204 is an example of an electronic device including a power storage device 8203 of one embodiment of the present invention. Specifically, the indoor unit 8200 includes a housing 8201, an air outlet 8202, the power storage device 8203, and the like. Although FIG. 13 illustrates the case where the power storage device 8203 is provided in the indoor unit 8200, the power storage device 8203 may be provided in the outdoor unit 8204. Alternatively, the power storage device 8203 may be provided in both the indoor unit 8200 and the outdoor unit 8204. The air conditioner can receive electric power from a commercial power source or use electric power stored in the power storage device 8203. Particularly in the case where the power storage device 8203 is provided in both the indoor unit 8200 and the outdoor unit 8204, the air conditioner can operate with the use of the power storage device 8203 of one embodiment of the present invention as an uninterruptible power source even when electric power cannot be supplied from a commercial power source because of power failure or the like.

Note that although the split-type air conditioner including the indoor unit and the outdoor unit is illustrated in FIG. 13 as an example, the power storage device of one embodiment of the present invention can be used in an air conditioner in which the functions of an indoor unit and an outdoor unit are integrated in one housing.

In FIG. 13, an electric refrigerator-freezer 8300 is an example of an electronic device including a power storage device 8304 of one embodiment of the present invention. Specifically, the electric refrigerator-freezer 8300 includes a housing 8301, a door for a refrigerator 8302, a door for a freezer 8303, the power storage device 8304, and the like. The power storage device 8304 is provided in the housing 8301 in FIG. 13. The electric refrigerator-freezer 8300 can receive electric power from a commercial power source or use electric power stored in the power storage device 8304. Thus, the electric refrigerator-freezer 8300 can operate with the use of the power storage device 8304 of one embodiment of the present invention as an uninterruptible power source even when electric power cannot be supplied from a commercial power source because of power failure or the like.

Note that among the electronic devices described above, the high-frequency heating appliances such as microwave ovens, the electric rice cookers, and the like require high electric power in a short time. The tripping of a circuit breaker of a commercial power source in use of the electronic devices can be prevented by using the power storage device of one embodiment of the present invention as an auxiliary power source for making up for the shortfall in electric power supplied from a commercial power source.

In addition, in a time period when electronic devices are not used, specifically when the proportion of the amount of electric power which is actually used to the total amount of electric power which can be supplied from a commercial power source (such a proportion is referred to as power usage rate) is low, electric power can be stored in the power storage device, whereby the power usage rate can be reduced in a time period when the electronic devices are used. For example, in the case of the electric refrigerator-freezer 8300, electric power can be stored in the power storage device 8304 in night time when the temperature is low and the door for a refrigerator 8302 and the door for a freezer 8303 are not often opened or closed. On the other hand, in daytime when the temperature is high and the door for a refrigerator 8302 and the door for a freezer 8303 are frequently opened and closed, the power storage device 8304 is used as an auxiliary power source; thus, the power usage rate in daytime can be reduced.

The use of a power storage device in vehicles can lead to next-generation clean energy vehicles such as hybrid electric vehicles (HEVs), electric vehicles (EVs), and plug-in hybrid electric vehicles (PHEVs).

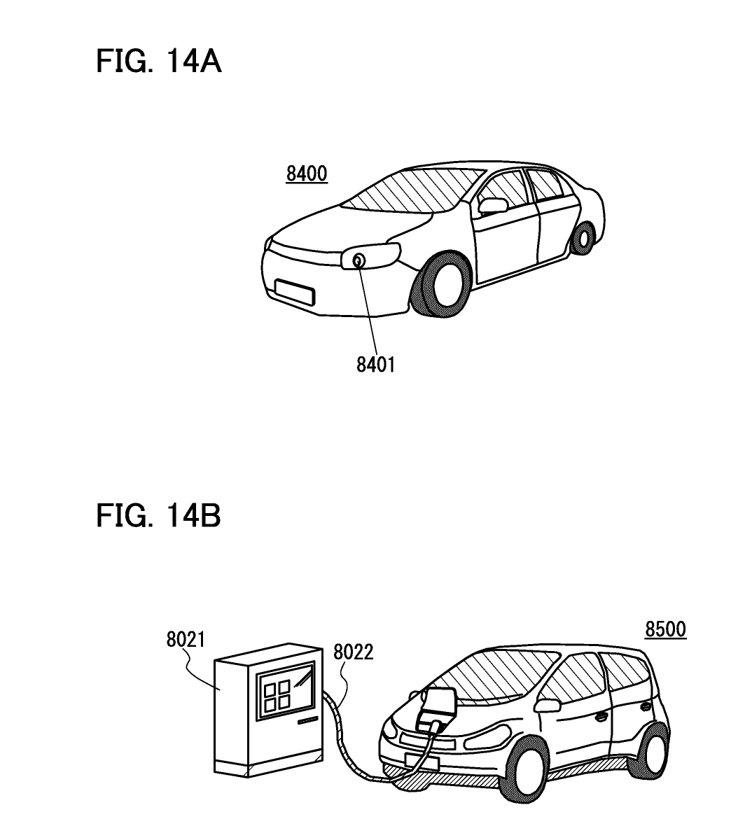

FIGS. 14A and 14B each illustrate an example of a vehicle using one embodiment of the present invention. An automobile 8400 illustrated in FIG. 14A is an electric vehicle which runs on the power of the electric motor. Alternatively, the automobile 8400 is a hybrid electric vehicle capable of driving using either the electric motor or the engine as appropriate. One embodiment of the present invention achieves a high-mileage vehicle. The automobile 8400 includes the power storage device. The power storage device is used not only for driving the electric motor, but also for supplying electric power to a light-emitting device such as a headlight 8401 or a room light (not illustrated).

The power storage device can also supply electric power to a display device included in the automobile 8400, such as a speedometer or a tachometer. Furthermore, the power storage device can supply electric power to a semiconductor device included in the automobile 8400, such as a navigation system.

FIG. 14B illustrates an automobile 8500 including the power storage device. The automobile 8500 can be charged when the power storage device is supplied with electric power through external charging equipment by a plug-in system, a contactless power supply system, or the like. In FIG. 14B, the power storage device included in the automobile 8500 is charged with the use of a ground-based charging apparatus 8021 through a cable 8022. In charging, a given method such as CHAdeMO (registered trademark) or Combined Charging System may be referred to for a charging method, the standard of a connector, or the like as appropriate. The charging apparatus 8021 may be a charging station provided in a commerce facility or a power source in a house. For example, with the use of a plug-in technique, a power storage device included in the automobile 8500 can be charged by being supplied with electric power from outside. The charging can be performed by converting AC electric power into DC electric power through a converter such as an AC-DC converter.

Although not illustrated, the vehicle may include a power receiving device so as to be charged by being supplied with electric power from an above-ground power transmitting device in a contactless manner. In the case of the contactless power supply system, by fitting the power transmitting device in a road or an exterior wall, charging can be performed not only when the automobile stops but also when moves. In addition, the contactless power supply system may be utilized to perform transmission/reception between vehicles. Furthermore, a solar cell may be provided in the exterior of the automobile to charge the power storage device when the automobile stops or moves. To supply electric power in such a contactless manner, an electromagnetic induction method or a magnetic resonance method can be used.

According to one embodiment of the present invention, the power storage device can have improved cycle characteristics and reliability. Furthermore, according to one embodiment of the present invention, the power storage device itself can be made more compact and lightweight as a result of improved characteristics of the power storage device. The compact and lightweight power storage device contributes to a reduction in the weight of a vehicle, and thus increases the driving distance. Moreover, the power storage device included in the vehicle can be used as a power source for supplying electric power to products other than the vehicle. In that case, the use of a commercial power supply can be avoided at peak time of electric power demand.

This embodiment can be implemented in appropriate combination with any of the other embodiments and example.

### Example 1

A laminated power storage unit 1200 having a structure disclosed in the above embodiments was fabricated and the charge and discharge capacity of the power storage unit 1200 before and after a repeated bending test was measured.

### <Structure of Power Storage Unit>

First, a structure of the fabricated laminated power storage unit 1200 will be described.

### [Positive Electrode]

A 20 μm-thick aluminum film was used as a positive electrode current collector. A positive electrode active material layer was formed over the positive electrode current collector. The positive electrode active material layer was formed by mixing an active material, a conductive additive, and a binder. LiCoO₂, acetylene black, and polyvinylidene fluoride (PVdF) were used as the positive electrode active material, the conductive additive, and the binder, respectively. The content of the conductive additive in the positive electrode active material layer was 5 wt %. The content of the binder will be described below.

### [Negative Electrode]

A 18 μm-thick copper film was used as a negative electrode current collector. A negative electrode active material layer was formed over the negative electrode current collector. The negative electrode active material layer was formed by mixing a negative electrode active material and a binder. MCMB (artificial graphite) and polyvinylidene fluoride (PVdF) were used as the negative electrode active material and the binder, respectively. The content of the binder will be described below.

### [Electrolyte Solution]

The electrolyte solution used was obtained as follows: 1 mol of LiPF₆ was dissolved in 1 L of solvent in which ethylene carbonate (EC) and diethyl carbonate (DEC) were mixed at a volume ratio of 3:7.

### [Separator]

Polypropylene (PP) was used as a separator.

### [Exterior Body]

The exterior body used is a laminate film with a three-layer structure in which aluminum is interposed between nylon and polypropylene. The positive electrode, the negative electrode, the electrolyte solution, and the separator are provided on the polypropylene side of the laminate film.

### <Repeated Bending Test>

Repeated bending test machine, method, and results will be described below.

### [Test Machine]

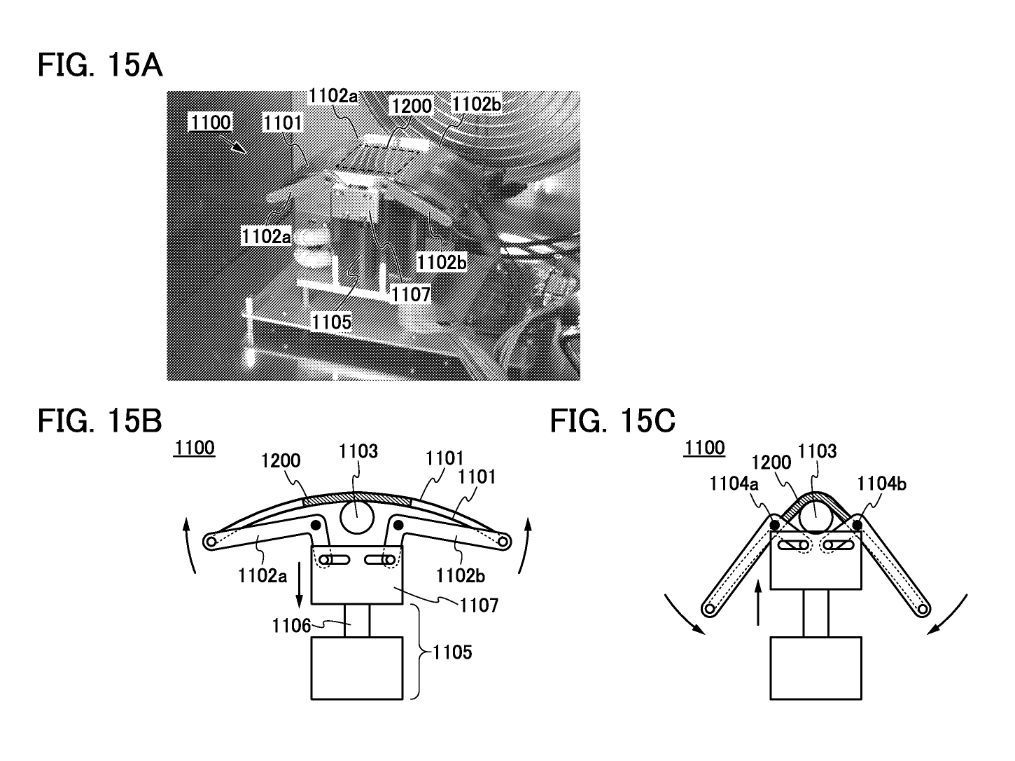

FIG. 15A is a photograph showing the appearance of a test machine 1100. FIGS. 15B and 15C are side views of the test machine 1100, which show the operation of the test machine 1100. In FIGS. 15B and 15C, part of the components of the test machine 1100 is omitted for the sake of clarity.

The fabricated power storage unit 1200 is disposed in the upper part of the test machine 1100, being interposed between a pair of support plates 1101. The support plates 1101 need to be made of a material having flexibility and being able to withstand the repeated bending test. In this example, the support plates 1101 are, but are not limited to, 0.2-mm-thick phosphor bronze plates. The material of the support plates 1101 is not necessarily a metal material such as phosphor bronze, but may be a resin material or the like. Note that phosphor bronze used for the support plates 1101 has light-blocking properties. In FIG. 15A, the power storage unit 1200 is blocked by the support plates 1101 and therefore cannot be seen directly. Thus, the power storage unit 1200 is represented by a dashed line in FIG. 15A.

In the test machine 1100, a cylindrical support 1103 with a radius of 40 mm is provided directly below the power storage unit 1200 to extend in the depth direction (see FIGS. 15B and 15C).

The test machine 1100 includes L-shaped arms 1102a and 1102b each having a long axis and a short axis. The test machine 1100 also includes an air cylinder 1105 having a rod 1106, and a component 1107.

The arm 1102a is provided on the left of the support 1103 with its long and short axes extending leftward and downward, respectively. The arm 1102b is provided on the right of the support 1103 with its long and short axes extending rightward and downward, respectively (see FIGS. 15B and 15C). The intersection of the long and short axes of the arm 1102a is mechanically connected to a pivot 1104a, and the intersection of the long and short axes of the arm 1102b is mechanically connected to a pivot 1104b. Note that the support 1103 and the pivots 1104a and 1104b are fixed.

The edge of the short axis of each of the arms 1102a and 1102b is mechanically connected to the component 1107. The edge of the long axis of the arm 1102a is mechanically connected to an end of the support plates 1101, and the edge of the long axis of the arm 1102b is mechanically connected to the other end of the support plates 1101.

The rod 1106 in the air cylinder 1105 can move with compressed air. For example, the rod 1106 in the air cylinder 1105 moves up and down in this example.

The component 1107 is connected to the rod 1106 and moves up and down with the rod 1106.

When the component 1107 moves down, the arm 1102a rotates around the pivot 1104a, so that the edge of the long axis ascends. Also when the component 1107 moves down, the arm 1102b rotates around the pivot 1104b, so that the edge of the long axis ascends (see FIG. 15B). When the component 1107 moves up, the arm 1102a rotates around the pivot 1104a, so that the edge of the long axis descends. Also when the component 1107 moves up, the arm 1102b rotates around the pivot 1104b, so that the edge of the long axis descends (see FIG. 15C).

As described above, the edges of the long axes of the arms 1102a and 1102b are mechanically connected to the respective ends of the support plates 1101. When the edges of the long axes of the arms 1102a and 1102b move down, the support plates 1101 can be bent along the support 1103. In this example, the power storage unit 1200 is repeatedly bent while interposed between the pair of support plates 1101. Accordingly, when the edges of the long axes of the arms 1102a and 1102b move down (the component 1107 moves up), the power storage unit 1200 can be bent along the cylindrical support 1103 (see FIG. 15C). Specifically, in this example, the support 1103 has a radius of 40 mm and the power storage unit 1200 is bent with a curvature radius of 40 mm.

When the edges of the long axes of the arms 1102a and 1102b move up (the component 1107 moves down), there is less contact between the support 1103 and the power storage unit 1200, which increases the aforementioned curvature radius (see FIG. 15B). Specifically, in this example, the aforementioned curvature radius is 150 mm when the edges of the long axes of the arms 1102a and 1102b rise highest.

Since the power storage unit 1200 is repeatedly bent while interposed between the pair of support plates 1101, unnecessary force can be prevented from being applied to the power storage unit 1200. In addition, the whole power storage unit 1200 can be bent with a uniform force.

### [Test Method]

The repeated bending test was performed on a power storage unit 1200a and a power storage unit 1200b under the conditions shown in Table 1. In the power storage unit 1200a, both the positive and negative electrode active material layers contain 10 wt % of binder, and in the power storage unit 1200b, both the positive and negative electrode active material layers contain 5 wt % of binder.

TABLE 1

| | |
|---|---|
| Test temperature | 25° C. |
| State of charge | 100% charge |
| The largest | 150 mm |
| curvature | |
| radius | |
| The smallest | 40 mm |
| curvature | |
| radius | |
| Period | 10 seconds (Bend to be a state having the smallest |
| | curvature radius within 3 seconds, and hold 2 seconds. |
| | Bend to be a state having the largest curvature radius |
| | within 3 seconds, and hold 2 seconds.) |
| Bending times | 1000 times |

The charge and discharge capacity before and after the bending test was measured under the conditions shown in Table 2.

TABLE 2

| Range of voltage | 4.2 to 2.5 | V |
|---|---|---|
| Charging rate | 0.2 | C |
| Discharging rate | 0.2 | C |
| Process temperature | 25° | C. |

### [Test Results]

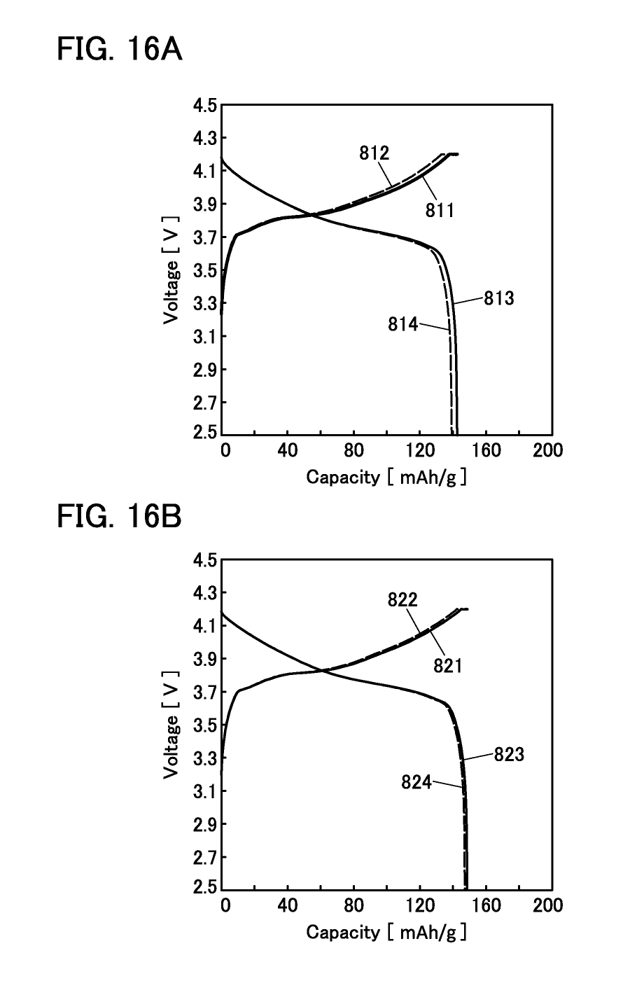

FIGS. 16A and 16B show the measurement results of the charge and discharge capacity. FIG. 16A shows the charge and discharge capacity of the power storage unit 1200a, and FIG. 16B shows the charge and discharge capacity of the power storage unit 1200b. In FIGS. 16A and 16B, the horizontal axis represents capacity per gram of the positive electrode active material layer and the vertical axis represents voltage.

In FIG. 16A, a curve 811 represents charge capacity before the repeated bending test; a curve 812, charge capacity after the repeated bending test; a curve 813, discharge capacity before the repeated bending test; and a curve 814, discharge capacity after the repeated bending test. In FIG. 16B, a curve 821 represents charge capacity before the repeated bending test; a curve 822, charge capacity after the repeated bending test; a curve 823, discharge capacity before the repeated bending test; and a curve 824, discharge capacity after the repeated bending test.

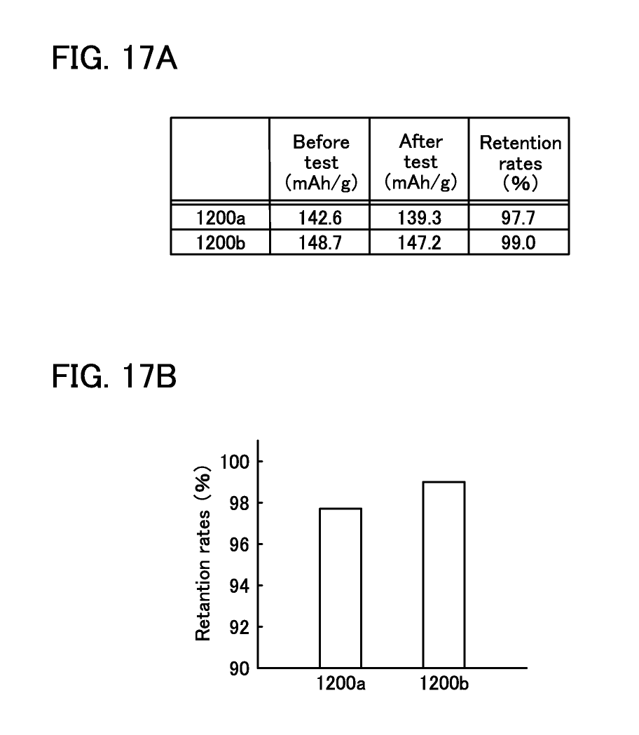

FIGS. 17A and 17B show the measurement results of the discharge capacity of the power storage units 1200a and 1200b before and after the repeated bending test. Note that the retention rate in FIG. 17A is the ratio of the discharge capacity after the test to the discharge capacity before the test, which is expressed in percentage. Bar graphs of FIG. 17B indicate the retention rates of the power storage units 1200a and 1200b shown in FIG. 17A. FIGS. 17A and 17B show that both of the power storage units 1200a and 1200b have a discharge capacity retention rate of 95% or more. In particular, the power storage unit 1200b has a discharge capacity retention rate of 99%, which means almost no reduction in capacity during the repeated bending test.

This application is based on Japanese Patent Application serial No. 2013-208840 filed with Japan Patent Office on Oct. 4, 2013, the entire contents of which are hereby incorporated by reference.

What is claimed is:

1. A power storage unit comprising:
a positive electrode comprising a positive electrode active material layer; and
a negative electrode comprising a negative electrode active material layer,
wherein the positive electrode active material layer comprises a positive electrode active material and a first binding agent,
wherein the negative electrode active material layer comprises a negative electrode active material and a second binding agent, and
wherein at least one of a first content and a second content is greater than or equal to 1 wt % and less than or equal to 10 wt %, the first content being a content of the first binding agent in the positive electrode active material layer, and the second content being a content of the second binding agent in the negative electrode active material layer.

2. The power storage unit according to claim 1,
wherein the power storage unit is configured to be bent.

3. The power storage unit according to claim 1,
wherein the positive electrode active material comprises LiFePO₄ or LiCoO₂.

4. The power storage unit according to claim 1,
wherein the negative electrode active material comprises graphite or silicon.

5. The power storage unit according to claim 1,
wherein each of the first binding agent and the second binding agent comprises any one of poly(vinylidene fluoride), a polyimide, tetrafluoroethylene, poly(vinyl chloride), an ethylene-propylene copolymer, a styrene-butadiene copolymer, an acrylonitrile-butadiene copolymer, poly(vinyl acetate), poly(methyl methacrylate), polyethylene, and nitrocellulose.

6. The power storage unit according to claim 1,
wherein the positive electrode active material layer further comprises a first conductive additive,
wherein the negative electrode active material layer further comprises a second conductive additive, and
wherein at least one of a third content and a fourth content is greater than or equal to 1 wt % and less than or equal to 10 wt %, the third content being a content of the first conductive additive in the positive electrode active material layer, and the fourth content being a content of the second conductive additive in the negative electrode active material layer.

7. An electronic device comprising:
a housing having a flexible portion; and
a power storage unit according to claim 1,
wherein the power storage unit is configured to be bent along the flexible portion.

8. A power storage unit comprising:
a positive electrode comprising a positive electrode active material layer; and
a negative electrode comprising a negative electrode active material layer,
wherein the positive electrode active material layer comprises a positive electrode active material and a first binding agent,
wherein the negative electrode active material layer comprises a negative electrode active material and a second binding agent, and
wherein at least one of a first content and a second content is greater than or equal to 3 wt % and less than or equal to 5 wt %, the first content being a content of the first binding agent in the positive electrode active material layer, and the second content being a content of the second binding agent in the negative electrode active material layer.

9. The power storage unit according to claim 8,
wherein the power storage unit is configured to be bent.

10. The power storage unit according to claim 8,
wherein the positive electrode active material comprises LiFePO₄ or LiCoO₂.

11. The power storage unit according to claim 8,
wherein the negative electrode active material comprises graphite or silicon.

12. The power storage unit according to claim 8,
wherein each of the first binding agent and the second binding agent comprises any one of poly(vinylidene fluoride), a polyimide, tetrafluoroethylene, poly(vinyl chloride), an ethylene-propylene copolymer, a styrene-butadiene copolymer, an acrylonitrile-butadiene copolymer, poly(vinyl acetate), poly(methyl methacrylate), polyethylene, and nitrocellulose.

13. The power storage unit according to claim 8,
wherein the positive electrode active material layer further comprises a first conductive additive,
wherein the negative electrode active material layer further comprises a second conductive additive, and
wherein at least one of a third content and a fourth content is greater than or equal to 1 wt % and less than or equal to 10 wt %, the third content being a content of the first conductive additive in the positive electrode active material layer, and the fourth content being a content of the second conductive additive in the negative electrode active material layer.

14. An electronic device comprising:
a housing having a flexible portion; and
a power storage unit according to claim 8,
wherein the power storage unit is configured to be bent along the flexible portion.
